(19) United States
(12) Patent Application Publication
(10) Pub. No.: US 2026/0164407 A1
(43) Pub. Date: Jun. 11, 2026

(54) METHOD AND APPARATUS FOR PAGING OPERATION IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/179,167

(22) Filed: Apr. 15, 2025

(30) Foreign Application Priority Data
Apr. 22, 2024 (KR) 1020240053245

(51) Int. Cl. H04W 68/02

(52) U.S. Cl. CPC H04W 68/02

(57) ABSTRACT

A method and apparatus to enhance paging operation to achieve network energy efficiency. The method includes receiving a system information, determining one or more PMOs and performing PDCCH monitoring for paging in the one or more PMOs. PMOs are determined based on a specific radio frame and a specific index. The specific radio frame is determined based on a second parameter in case that the second parameter is included in the system information. The specific radio frame is determined based on a first parameter in case that the second parameter is not included in the system information.

### CROSS-REFERENCE TO RELATED APPLICATION

This application claims priority to and the benefit of Korean Patent Application No. 10-2024-0053245, filed on Apr. 22, 2024, the disclosure of which is hereby incorporated herein by reference in its entirety.

### BACKGROUND

### Technical Field

The present disclosure relates to paging operation in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple—input multiple output (MIMO), full dimensional MIMO (FD-MIMO), array antenna, analog beamforming, and large-scale antenna. In addition, base station is divided into a central unit and plurality of distribute units for better scalability. In the advancement of 5G networks, one significant focus is improving network energy efficiency.

### SUMMARY

Aspects of the present disclosure are to enhance paging operation to achieve network energy efficiency. The method includes receiving a system information, determining one or more PMOs and performing PDCCH monitoring for paging in the one or more PMOs. PMOs are determined based on a specific radio frame and a specific index. The specific radio frame is determined based on a second parameter in case that the second parameter is included in the system information. The specific radio frame is determined based on a first parameter in case that the second parameter is not included in the system information.

### BRIEF DESCRIPTION OF THE DRAWINGS

FIG. 1 is a diagram illustrating the architecture of a 5G system and a NG-RAN.

FIG. 2 is a diagram illustrating a wireless protocol architecture in a 5G system.

FIG. 3 illustrates the overall operation of the UE and network.

FIG. 4 illustrates RRC connection establishment procedure.

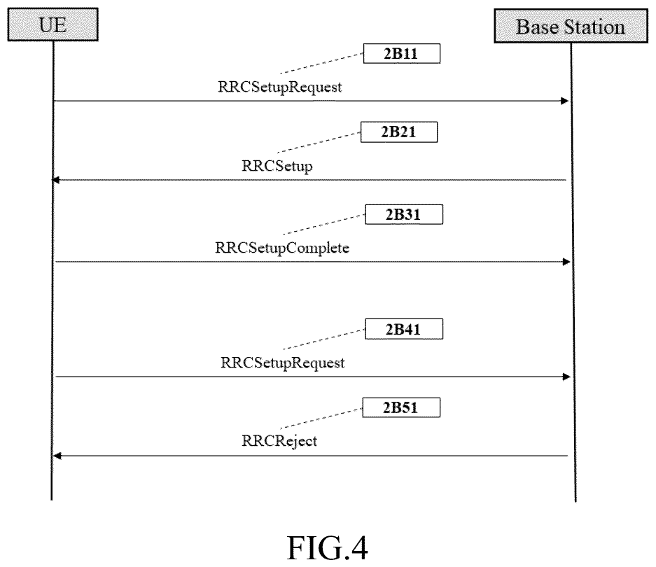

FIG. 5 illustrates RRC connection reconfiguration procedure.

FIG. 6 illustrates data transfer procedure in RRC_CONNECTED state.

FIG. 7 illustrates SS/PBCH block.

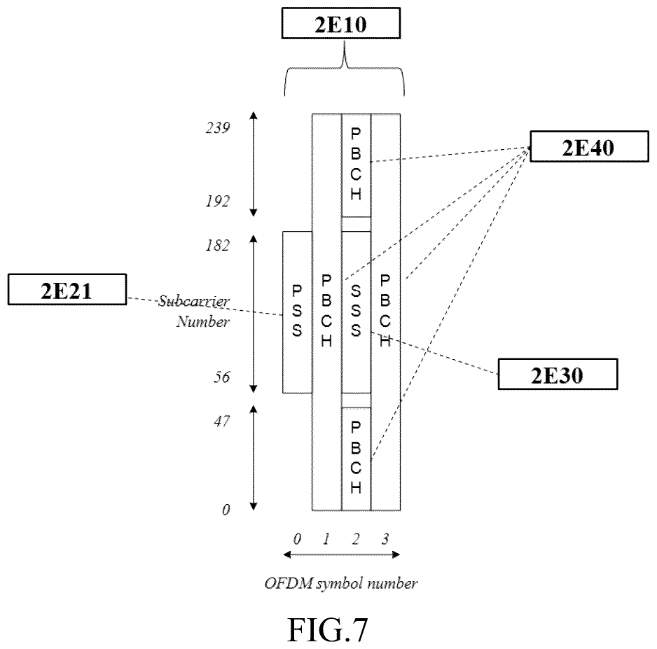

FIG. 8 compares various paging schemes.

FIG. 9 illustrates the first paging scheme.

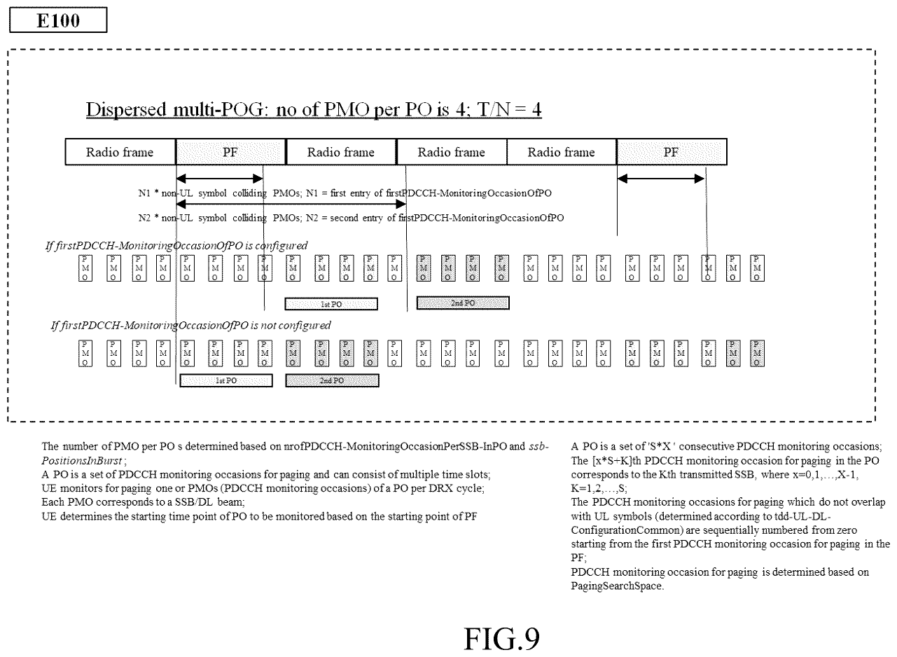

FIG. 10 illustrates the second paging scheme.

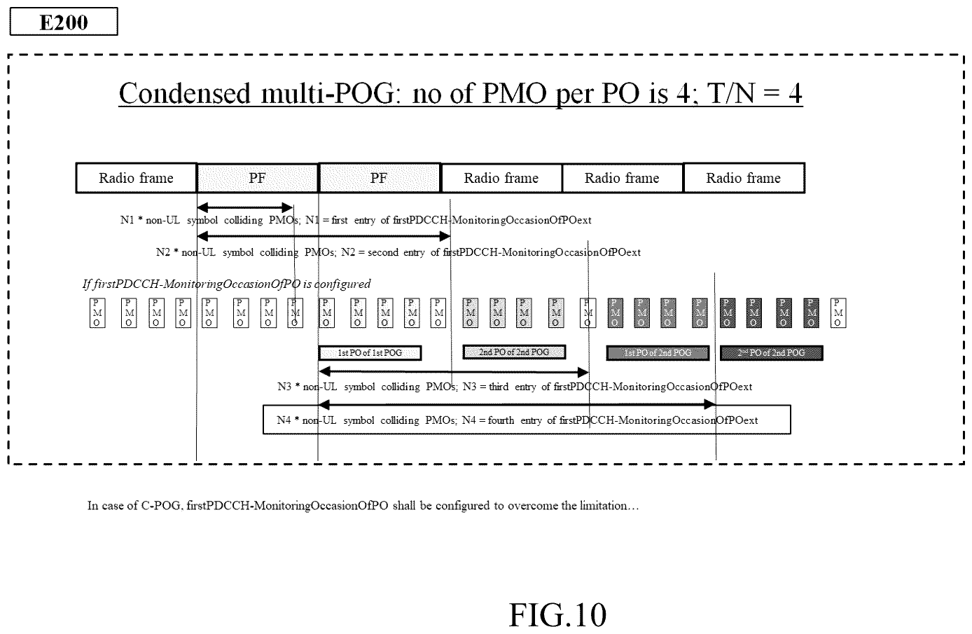

FIG. 11 illustrates the third paging scheme.

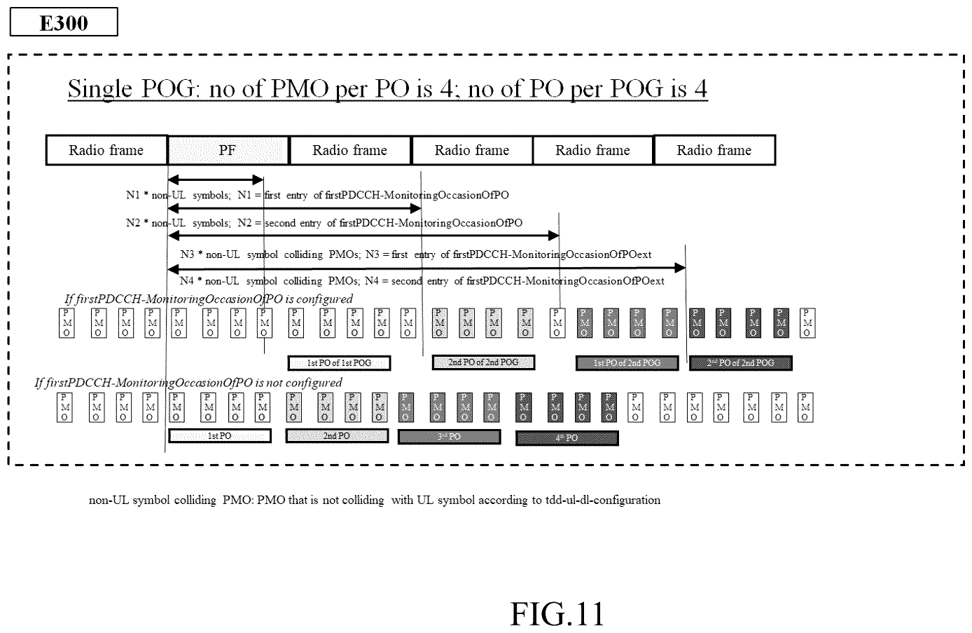

FIG. 12 illustrates the operation of the terminal and network.

FIG. 13 illustrates the operation of the terminal and network.

FIG. 14 is a diagram illustrating operations of the terminal.

FIG. 15 is a block diagram illustrating the internal structure of a UE according to the disclosure.

FIG. 16 is a block diagram illustrating the internal structure of a base station according to the disclosure.

### DETAILED DESCRIPTION

To facilitate energy saving in network side, a feasible solution is to provide opportunities for turning off downlink transmission in base station. One example of the downlink transmission to be turned off is system information. System information is periodically transmitted to provide unspecified multiple terminals in a cell necessary information for access.

Under certain circumstances, transmission of such system information may not be necessary if access to the cell can be delayed. For example, if the geographical coverage of the cell is covered by another cell, terminal may camp on the other cell (e.g. anchor cell) first and then access to the cell (non-anchor cell) from the other cell, possibly based on assistance information achieved from the other cell.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

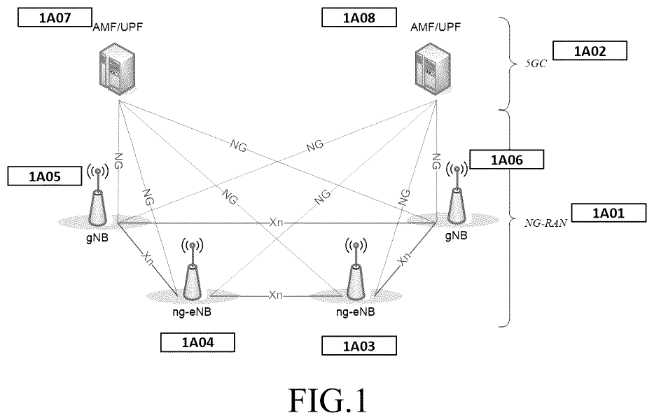

FIG. 1 is a diagram illustrating the architecture of a 5G system and a NG-RAN to which the disclosure may be applied.

5G system consists of NG-RAN 1A01 and 5GC 1A02. An NG-RAN node is either:

>1: a gNB, providing NR user plane and control plane protocol terminations towards the UE; or

>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

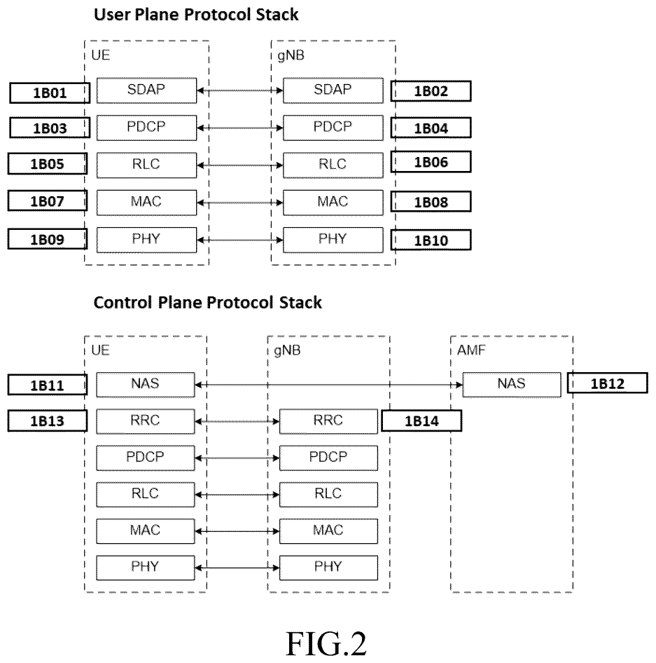

FIG. 2 is a diagram illustrating a wireless protocol architecture in a 5G system to which the disclosure may be applied.

The user plane protocol stack consists of SDAP 1B01 or 1B02, PDCP 1B03 or 1B04, RLC 1B05 or 1B06, MAC 1B07 or 1B08 and PHY 1B09 or 1B10. The control plane protocol stack consists of NAS 1B1I or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

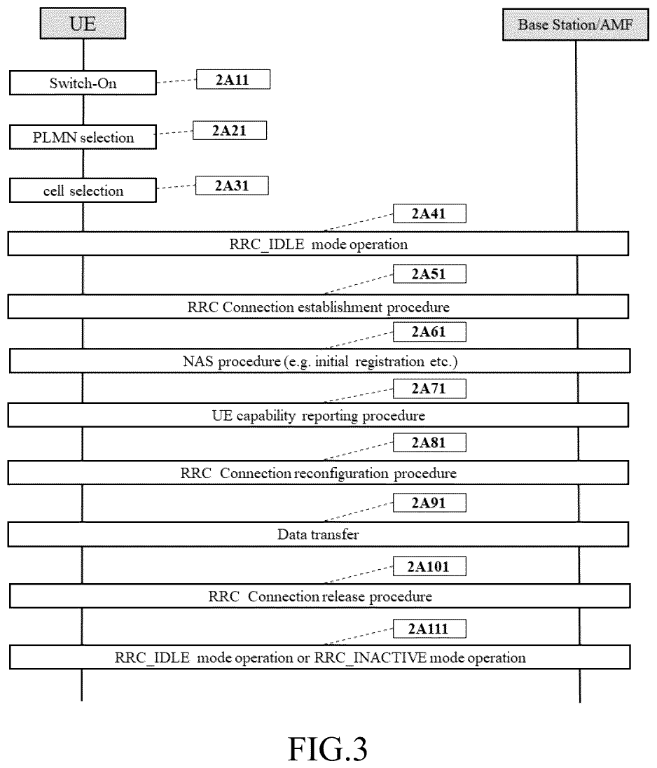

FIG. 3 illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates RRC connection establishment procedure.

### Successful RRC Connection Establishment Procedure Comprises:

>1: transmission of RRCSetupRequest by the UE 2B11;
>1: reception of RRCSetup by the UE 2B21;
>1: transmission of RRCSetupComplete by the UE 2B31.

### Unsuccessful RRC Connection Establishment Procedure Comprises:

>1: transmission of RRCSetupRequest by the UE 2B41;
>1: reception of RRCReject by the UE 2B51;

### RRCSetupRequest Comprises Following Fields and IEs:

>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc

### RRCSetup Comprises Following Fields and IEs:

>1: radioBearerConfig field containing a RadioBearerConfig IE;
>1: masterCellGroup field containing a CellGroupConfig IE.

### RRCSetupComplete Comprises Following Fields and IEs:

>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentitylnfoList;
>1: include the s-NSSAI-List and set the content to the values provided by the upper layers;

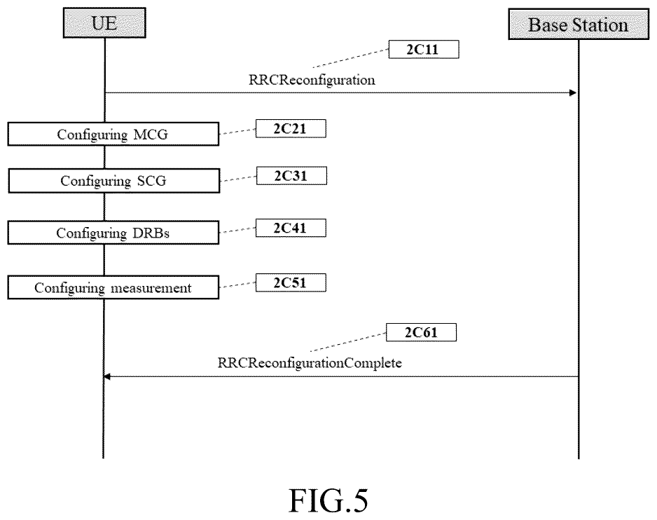

FIG. 5 illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that is applied to various use cases such as data radio bearer establishment, handover, cell group reconfiguration, DRX configuration, security key refresh and many others.

RRC reconfiguration procedure consists of exchanging RRCReconfiguration 2C11 and RRCReconfigurationComplete 2C61 between the base station and the UE.

RRCReconfiguration may comprise following fields and IEs:
>1: rrc-Transactionldentifier field contains a RRC-Transactionldentifier IE;
>1: radioBearerConfig field contains a RadioBearerConfig IE;
>>2: radioBearerConfig field comprises configuration information for SRBs and DRBs via which RRC messages and user traffic are transmitted and received;
>1: secondaryCellGroup field contains a CellGroupConfig IE;
>>2: secondaryCellGroup field comprises configuration information for secondary cell group;
>>2: A cell group consists of a SpCell and zero or more SCells;
>>2: Cell group configuration information comprises cell configuration information for SpCell/SCell and configuration information for MAC and configuration information for logical channel etc;
>1: measConfig field contains a MeasConfig IE;
>>2: measConfig field comprises configuration information for measurements that the UE is required to perform for mobility and other reasons.
>1: masterCellGroup field contains a CellGroupConfig IE;

Upon reception of RRCReconfiguration, UE processes the IEs in the order as below.

### Ue May:

>1: perform the cell group configuration for MCG based on the received masterCellGroup 2C21;
>1: perform the cell group configuration for SCG based on the received secondaryCellGroup 2C31;
>1: perform the radio bearer configuration based on the received radioBearerConfig 2C41;
>1: perform the measurement configuration based on the received measConfig 2C51; After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

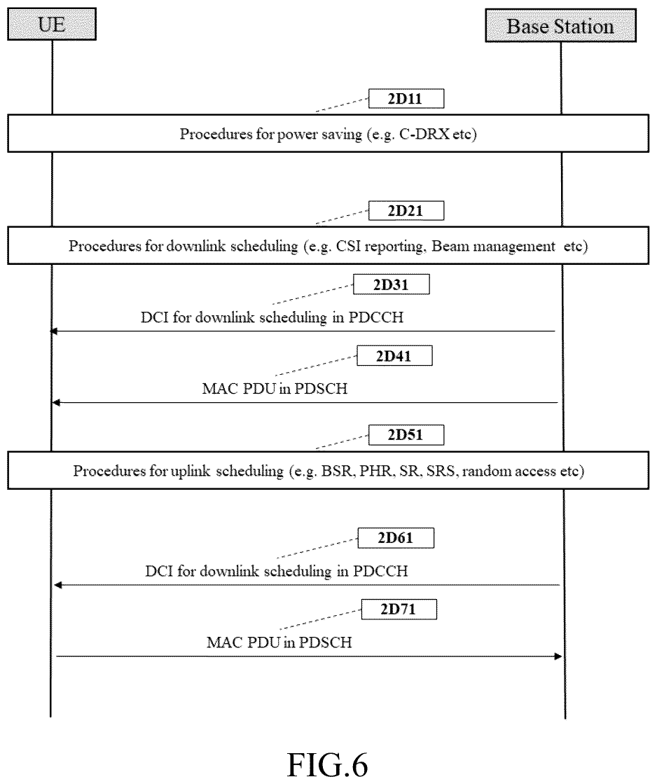

FIG. 6 illustrates data transfer procedure in RRC_CONNECTED state.

The UE and the base station may perform procedures for power saving such as C-DRX 2D11. The configuration information for C-DRX is provided to the UE within cell group configuration in the RRCReconfiguration.

The UE and the base station may perform various procedures for downlink scheduling 2D21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2D31. The base station transmits to the UE PDSCH corresponding to the DCI and containing a MAC PDU 2D41.

The UE and the base station may perform various procedure for uplink scheduling 2D51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2D61. The base station transmits to the UE PDSCH corresponding to the DCI and containing a MAC PDU 2D71.

The Synchronization Signal and PBCH block (SSB) 2E10 consists of primary synchronization signals (PSS) 2E20 and secondary synchronization signals (SSS) 2E30. PSS and SSS occupies 1 symbol and 127 subcarriers. PBCH 2E40 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Paging transmission with short periodicity consumes significant base station energy. NR system uses a paging transmission scheme that keeps base station transmitter awake by dispersing Paging Opportunities across time domain. It is a reasonable approach in a sense that random access congestion may occur otherwise.

Since various types of networks/cells have been deployed (and will be deployed), random access congestion may not be an issue in some cases (e.g. in low load cell where random access congestion may not occur), where “dispersing paging opportunities” may only consume network energy without tangible benefits.

By condensing paging opportunities in time domain, base station may turn off the receiver until the next paging opportunities that leads to network energy saving.

UE may support either only baseline PO determination scheme (dispersed multi-PO group) or enhanced PO determination scheme also (condensed multi-PO group or Single PO group).

For RAN paging, based on UE capability and base station capability, the base station transmits paging message for the UE according to the baseline scheme or enhanced scheme.

For CN paging, based on UE capability and base station capability and CN capability, the base station transmits paging message for the UE according to the baseline scheme or enhanced scheme.

### Baseline Paging Scheme and Enhanced Paging Scheme

Paging scheme and PO determination scheme are used interchangeably.

Enhanced paging scheme and NES paging scheme are used interchangeably.

Enhanced paging (transmission/scheme/reception) and NES paging (transmission/scheme/reception) are used interchangeably.

PTW is CN configured PTW if not stated otherwise.

Paging is either paging message or paging transmission or paging reception or paging scheme.

DRX cycle and DRX value and T are used interchangeably.

“consist of” and “comprise” are used interchangeably.

TABLE 1

| CN paging | RAN paging |
|---|---|
| >: Initiated by CN/AMF | >: Initiated by GNB |
| >: Paging message comprises 5G-S-TMSI | >: Paging message comprises fullI-RNTI |
| >: Monitored and received by both UEs in >: | >: Monitored and received by UEs in |
| RRC_IDCLE and UEs in RRC_INACTIVE | RRC_INACTIVE |

TABLE 2

| Baseline paging | NES paging |
|---|---|
| Paging that is applied when a specific indication | Paging that is applied to a UE: |
| regarding NES paging is not comprised in a specific | >: when a specific indication regarding NES paging is |
| system information. | comprised in a specific system information; and |
| Paging that is applied to UEs that does not support | >: when the UE supports NES paging (UEs that are |
| NES paging (UEs that are not configured with NES | configured with NES paging). |
| paging). | Paging opportunities for a DRX cycle are condensed |
| Paging opportunities for a DRX cycle are dispersed | in a specific part of the DRX cycle. |
| over the DRX cycle. | |

UE Operates in NES Paging in a Cell in Case that:
>: For RRC_IDLE
>>: The cell broadcast in SIB 1 an indication that NES paging for RRC_IDLE is supported in the cell; and
>>: UE is configured with NES paging by upper layers (e.g. NAS message comprises information related to NES paging has been received)
>: For RRC_INACTIVE
>>: The cell broadcast in SIB 1 an indication that NES paging for RRC_INACTIVE is supported in the cell; and
>>: UE is configured with NES paging by RRC (e.g. RRCRelease comprises information related to NES paging has been received) (or UE is configured with NES paging by upper layers).

### PTW:

>: Time period for a UE, in case that the UE operates in extended DRX, during which paging is transmitted
>: Configuration parameters for PTW are comprised in a NAS message

Paging opportunity for a UE during a DRX cycle consists of one or more PMOs or a PO

### PMO:

>: PDCCH monitoring occasion for paging;
>: A PMO consists of one or more consecutive symbols (indicated by monitoringSymbolsWithinSlot in SearchSpace IE corresponding to pagingSearchSpace);
>: A PMO resides in a slot;
>: The PMOs which do not overlap with UL symbols (determined according to tdd-UL-DL-ConfigurationCommon) are sequentially numbered from zero starting from the first PMO in the PF.

### PO/PMOG:

>: Paging Occasion/PMO Group
>: A set of consecutive PMOs;
>: A PO consists of one or more time slots (A PO may span across two or more slots);
>: A PO consists of S*X′ consecutive PMOs:
>>: S is the number of actual transmitted SSBs determined according to ssb-PositionsInBurst in SIB1;
>>: X is the nrofPDCCH-MonitoringOccasionPerSSB-InPO if configured or is equal to 1 otherwise;
>>: The [x*S+K]^{th} PMO in the PO corresponds to the K^{th} transmitted SSB; POG:
>: Paging Occasion Group;
>: A POG consist of Ns/NsExt consecutive POs;
>: A POG is associated with a reference point (e.g. a first symbol of a Paging Frame);
>: Each PO of the POG is indexed from 0 to Ns—1 sequentially;
>: One POG per DRX cycle.

### PF (or Reference Point):

>: Paging Frame;
>: A PF provides the reference point to determine starting point of one or more POs (the one or more POs that belong to the same POG);
>: The reference point to determine the starting point is the first PMO of a specific radio frame (e.g. PF)

T_CN: UE specific DRX value configured by upper layers (comprised in Registration Accept message).

T_RAN: UE specific DRX value configured by RRC (Comprised in RRCRelease).

T_E_CN: TeDRX_CN (comprised in Registration Accept message), extended DRX value/cycle for CN paging, T_E_CN. Configured by Extended DRX parameters.

T_E_RAN: T_E_RAN (comprised in RRCRelease), extended DRX value/cycle for RAN paging, T_eDRX_RAN. Configured by ExtendedPagingCycle-r17

T_D: cell specific default DRX value broadcast in system information (SIB1).

First set of UE_IDs/UE ID based groupo1: Group of UEs that each UE ID are apart at least by N (or N-1) from each other (closet UE IDs are apart by N; UE ID 0 and UE ID N belongs to the same first set of UE_IDs). UEs with UE ID mod N resulting the same integer belong to the same UE ID based group1. Each group is associated with an integer/Group ID that is determined from ‘any UE_ID of the group’ mod N.

Second set of UE_IDs/UE ID based group2: Group of UEs that closest UE IDs are adjacent from each other. Number of UEs within a UE ID based group2 is N. UEs with UE ID div N resulting the same integer belong to the same UE ID based group2. Each group is associated with an integer/Group ID that is determined from ‘any UE_ID of the group’ div N.
N: number of total paging frames in T (or number of RPs in T)
PF_offset: offset used for PF determination
Ns: number of paging occasions for a PF (number of POs for a RP; number of POs of a POG)
UE_ID: 10 LSBs (if UE does not operate in eDRX) or 12 LSBs (if UE operates in eDRX) of 5G-S-TMSI of the UE. It is used to determine PF (RP) and PO index (PMOG index)
first_T, first_N: parameters/inputs that are used to determine the specific frame (PF) that contains the reference time point (reference PMO, first PMO).
Second_T, second_N: parameters/inputs that are used to determine PO index.

For UE in RRC_IDLE: first_T and second_T are identical/same; first_N and second_N are identical/same.

For UE in RRC_INACTIVE: first_T and second_T are different in specific cases; First_N and second_N are different in the specific cases; first_T and second_T are same in other cases. First_N and second_N are same in other cases.

| | |
|---|---|
| <firstPDCCH-MonitoringOccasionOfPO, | firstPDCCH-MonitoringOccasionOfPO- |

v1710>

| | |
|---|---|
| firstPDCCH-MonitoringOccasionOfPO | CHOICE { |

```
      sCS15KHZoneT
SEQUENCE (SIZE (1..maxPO-perPF)) OF INTEGER (0..139),
      sCS30KHZoneT-SCS15KHZhalfT
SEQUENCE (SIZE (1..maxPO-perPF)) OF INTEGER (0..279),
      sCS60KHZoneT-SCS30KHZhalfT-SCS15KHZquarterT
SEQUENCE (SIZE (1..maxPO-perPF)) OF INTEGER (0..559),
      sCS120KHZoneT-SCS60KHZhalfT-SCS30KHZquarterT-
```

| | |
|---|---|
| SCS15KHZoneEighthT | SEQUENCE (SIZE (1..maxPO-perPF)) OF INTEGER |

(0..1119),
sCS120KHZhalfT-SCS60KHZquarterT-SCS30KHZoneEighthT-

| | |
|---|---|
| SCS15KHZoneSixteenthT | SEQUENCE (SIZE (1..maxPO-perPF)) OF INTEGER |

(0..2239),
sCS480KHZoneT-SCS120KHZquarterT-SCS60KHZoneEighthT-

| | |
|---|---|
| SCS30KHZoneSixteenthT | SEQUENCE (SIZE (1..maxPO-perPF)) OF INTEGER |

```
(0..4479),
      sCS480KHZhalfT-SCS120KHZoneEighthT-SCS60KHZoneSixteenthT
SEQUENCE (SIZE (1..maxPO-perPF)) OF INTEGER (0..8959),
      sCS480KHZquarterT-SCS120KHZoneSixteenthT
SEQUENCE (SIZE (1..maxPO-perPF)) OF INTEGER (0..17919)
```

| | | |
|---|---|---|
| } | OPTIONAL, | -- Need R |

| | |
|---|---|
| firstPDCCH-MonitoringOccasionOfPO-v1710 | CHOICE { |
| sCS480KHZoneEighthT | SEQUENCE (SIZE (1..maxPO-perPF)) OF |

INTEGER (0..35839),

| | |
|---|---|
| sCS480KHZoneSixteenthT | SEQUENCE (SIZE (1..maxPO-perPF)) OF |

INTEGER (0..71679)
}
OPTIONAL -- Need R

In case of D-POG/baseline paging, this field, if present, points out the first PMO of each PO of a PF.

In case of C-POG/NES paging, this field, if present, points out the first PMO of each PO of a first PF.

<firstPDCCH-MonitoringOccasionOfPOext>

| | |
|---|---|
| firstPDCCH-MonitoringOccasionOfPOext | CHOICE { |

```
      sCS15KHZoneT
SEQUENCE (SIZE (1..maxPO-perPF)) OF INTEGER (0..559),
      sCS30KHZoneT-SCS15KHZhalfT
SEQUENCE (SIZE (1..maxPO-perPF)) OF INTEGER (0..1119),
      sCS60KHZoneT-SCS30KHZhalfT-SCS15KHZquarterT
SEQUENCE (SIZE (1..maxPO-perPF)) OF INTEGER (0..2239),
      sCS120KHZoneT-SCS60KHZhalfT-SCS30KHZquarterT-
```

| | |
|---|---|
| SCS15KHZoneEighthT | SEQUENCE (SIZE (1..maxPO-perPF)) OF INTEGER |

(0..4479),
sCS120KHZhalfT-SCS60KHZquarterT-SCS30KHZoneEighthT-

| | |
|---|---|
| SCS15KHZoneSixteenthT | SEQUENCE (SIZE (1..maxPO-perPF)) OF INTEGER |

(0..8959),
sCS480KHZoneT-SCS120KHZquarterT-SCS60KHZoneEighthT-

| | |
|---|---|
| SCS30KHZoneSixteenthT | SEQUENCE (SIZE (1..maxPO-perPF)) OF INTEGER |

```
(0..17919),
      sCS480KHZhalfT-SCS120KHZoneEighthT-SCS60KHZoneSixteenthT
SEQUENCE (SIZE (1..maxPO-perPF)) OF INTEGER (0..35839),
      sCS480KHZquarterT-SCS120KHZoneSixteenthT
SEQUENCE (SIZE (1..maxPO-perPF)) OF INTEGER (0..71679)
```

| | | |
|---|---|---|
| } | OPTIONAL, | -- Need R |

| | |
|---|---|
| firstPDCCH-MonitoringOccasionOfPO-v1710 | CHOICE { |
| sCS480KHZoneEighthT | SEQUENCE (SIZE (1..maxPO-perPF)) OF |

INTEGER (0..143359),

| | |
|---|---|
| sCS480KHZoneSixteenthT | SEQUENCE (SIZE (1..maxPO-perPF)) OF |

INTEGER (0..286719)
}
OPTIONAL -- Need R

This field is present for NES paging. This field is absent if NES paging is not configured.

In case of C-POG/NES paging, this field, if present, points out the first PMO of each PO of PFs starting from the second PF until the last PF.

In case of S-POG/NES paging, this field, if present, points out the first PMO of each PO.

In general, PMO/PO/PF are determined as below:
>: A DRX cycle of a UE consists of one or more RPs (N RPs);
>: A RP is associated with a POG (one or more consecutive POs);
>: A POG consists of one or more consecutive POs (Ns/NsExt POs);
>: A PO consists of one or more consecutive PMOs (S*X PMOs);
>: A DRX cycle consists of (N*Ns*S*X) PMOs;
>>: N instances of consecutive (Ns/NsExt*S*X) PMOs;
>>: N instances of consecutive Ns/NsExt POs;
>: UE determines a RP among N RPs:
>>: UE determines a PF; and
>>: UE determines RP based on the determined PF;
>: UE determines a PO from one of more POs of the POG associated with the RP;
>: UE determines index of the PO to be monitored (i_s);
>: UE determines the time domain locations of PMOs of the PO to be monitored.
>>: If firstPDCCH-MonitoringOccasionOfPO is configured:
>>>: the starting PDCCH monitoring occasion (PMO) number of (i_s+1)^{th} PO is the (i_s+1)^{th} value of the firstPDCCH-MonitoringOccasionOfPO parameter
>>: If firstPDCCH-MonitoringOccasionOfPO is not configured:
>>>: The starting PMO number is equal to i_s*S*X.
>>: PMO number and the time domain starting point of the corresponding PMO is determined based on SearchSpace IE of pagingSearchSpace and tdd-UL-DL-ConfigurationCommon
>: UE monitors one or more PMOs of the determined PO based on RSRP of downlink pathloss reference (e.g. SSB).

The value included in firstPDCCH-Monitoring0ccasionOfPO or firstPDCCH-MonitoringOccasionOfPOext indicates at which symbol is the first symbol of the first PMO of the corresponding PO (symbol number of the first symbol of the first PMO; symbol number of the first symbol of the paging frame is 0).

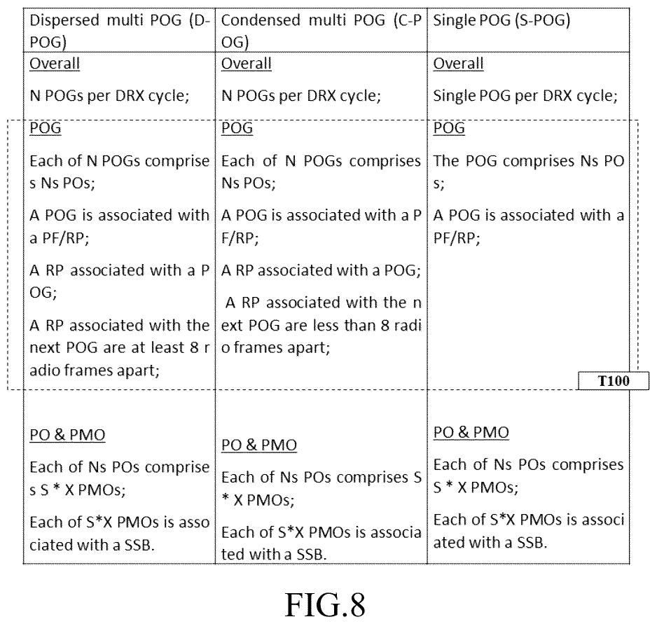

FIG. 8 compares paging schemes in terms of structure. As shown in T100, three paging schemes have different ways of constructing POG.

Table 3 compares paging schemes in terms of relevant parameters.

TABLE 3

| | Dispersed multi POG (D-POG) | Condensed multi POG (C-POG) | Single POG (S-POG) |
|---|---|---|---|
| Paging | (SFN + PF_offset) mod T = | (SFN + PF_offset) mod T = | SFN mod T = PF_offset |
| Frame | (T div N)*(UE_ID mod N) | (UE_ID mod N) | |

| RP | The first PMO of the PF (PMO #0) | |
|---|---|---|
| Paging | i_s = floor (UE_ID/N) mod Ns; or | i_s = UE_ID mod Ns |
| Occasion | i_s = (UE_ID div N) mod Ns | |
| PMO | Determined based on b best SSBs, b is UE implantation specific integer | |
| N & | N: number of total paging frames in T (or number of RPs in T) | N is fixed to 1 (or N is not used); |
| PF_offset | PF_offset: offset used for PF determination | PF_offset: offset used for PF |
| | The values of N and PF_offset are derived from the | determination; |
| | parameter nAndPagingFrameOffset | The value of PF_offset is derived |

from the parameter frameOffset;

| | |
|---|---|
| Ns | number of paging occasions for a PF (number of POs for a RP; number of POs of a POG) |
| | In case of D-POG and C-DOG, Ns is derived from parameter Ns; |
| | In case of S-POG, Ns is derived from parameter Ns (if NsExt is not present) or from parameter |
| | NsExt (if present) |
| UE_ID | If the UE operates in eDRX as specified in clause 7.4: |
| | >: 5G-S-TMSI mod 4096 |
| | else: |
| | >: 5G-S-TMSI mod 1024 |

For all paging schemes, T is determined as below.

T is DRX cycle/value of the UE that is used to determine RP and PO index.

T_E_CN and T_E_CN are used interchangeably.

T_E_RAN and T_eDRX_RAN are used interchangeably.

UE specific DRX value configured by RRC is T_RAN.

UE specific DRX value configured by upper layers is T_CN.

If the UE does not operate in eDRX as defined:
>: T is determined by the shortest of the UE specific DRX value configured by RRC (if any), the UE specific DRX value configured by upper layers (if any), and a default DRX value broadcast in system information. For L2 U2N Relay UE, T for a L2 U2N Remote UE is determined by the shortest of the UE specific DRX value provided in PC5-RRC signalling and a default DRX value broadcast in system information.

In RRC_IDLE state, if the UE operates in eDRX and eDRX is configured by upper layers, i.e., T_E_CN, according to clause 7.4:
>: If T_E_CN is no longer than 1024 radio frames:
>>: T=T_E_CN;
>: else:
>>: During CN configured PTW, T is determined by the shortest of UE specific DRX value, if configured by upper layers, and the default DRX value broadcast in system information.

In RRC_INACTIVE state, if the UE operates in eDRX and eDRX is configured by RRC, i.e., T_eDRX_RAN (if any), and upper layers, i.e., T_E_CN:
>: If both T_E_CN and used T_eDRX_RAN are no longer than 1024 radio frames, T=min{T_eDRX_RAN, T_E_CN}.
>: If T_E_CN is no longer than 1024 radio frames and no T_eDRX_RAN is configured or used, T is determined by the shortest of UE specific DRX value configured by RRC and T_E_CN.
>: If T_E_CN is longer than 1024 radio frames:
>>: If T_eDRX_RAN is not configured or used:
>>>: During CN configured PTW, T is determined by the shortest of the UE specific DRX value configured by RRC, the UE specific DRX value configured by upper layers (if any), and a default DRX value broadcast in system information. Outside the CN configured PTW, T is determined by the UE specific DRX value configured by RRC;
>>: else if used T_eDRX_RAN is no longer than 1024 radio frames:
>>>: During CN configured PTW, T is determined by the shortest of the UE specific DRX value, if configured by upper layers and T_eDRX_RAN, and a default DRX value broadcast in system information. Outside the CN configured PTW, T is determined by T_eDRX_RAN;
>>: else if used T_eDRX_RAN is longer than 1024 radio frames:
>>>: During the overlapped part of CN configured PTW and RAN configured PTW, T is determined by the shortest of the UE specific DRX value configured by RRC, the UE specific DRX value configured by upper layers (if any), and a default DRX value broadcast in system information;
>>>: During CN configured PTW and outside RAN configured PTW, T is determined by the shortest of the UE specific DRX value configured by upper layers (if any), and a default DRX value broadcast in system information;
>>>: Outside CN configured PTW and during RAN configured PTW, T is determined by the UE specific DRX value configured by RRC.

Paging schemes can be characterized in terms of PO and POGs as below.

TABLE 4

| | POs & POGs |
|---|---|
| | the first PO group and the second PO group are in the same DRX cycle; |
| | there is no other PO group between the first PO group and the second PO group; |
| D-Multi | The distance between the first PO group and the second PO group is T/N radio frames in time |
| POG | domain; |
| | Distance between adjacent POs within a PO group is smaller than distance between the last |
| | PO of a first PO group (e.g. preceding PO group) and the first PO of a second PO group (e.g. |
| | PO group that follows the preceding PO group); |
| | The distance between reference points of the adjacent PO groups is T/N radio frames. |
| C-Multi | The distance between the first PO group and the second PO group is determined based on |
| POG | n-th entry and (n + m)th entry of firstPDCCH-MonitoringOccasionOfPOExt; m = ns |
| | Distance between adjacent POs within a PO group is smaller than distance between the last |
| | PO of a first PO group (e.g. preceding PO group) and the first PO of a second PO group (e.g. |
| | following PO group); |
| | The distance between reference points of the adjacent PO groups is T/N radio frames. |
| S-POG | Distance between adjacent POs is determined based on n-th entry and (n + 1)th entry of |
| | firstPDCCH-MonitoringOccasionOfPOExt; |

E100 is an exemplary illustration of D-Multi-POG scheme when 4 PMOs per PO is configured.

E200 is an exemplary illustration of C-Multi-POG scheme when 4 PMOs per PO is configured.

E300 is an exemplary illustration of S-POG scheme when 4 POs per POG is configured.

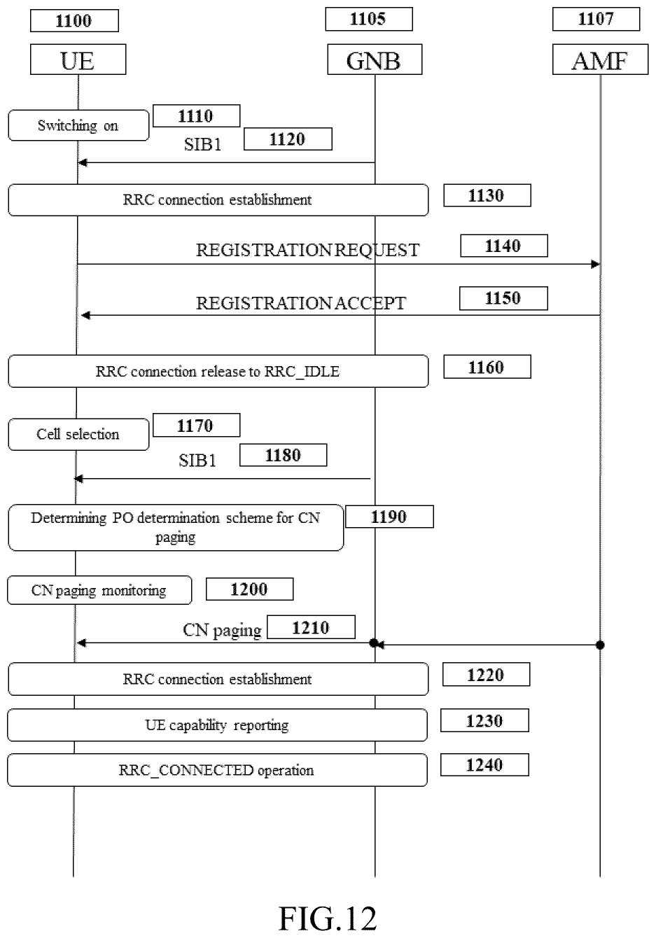

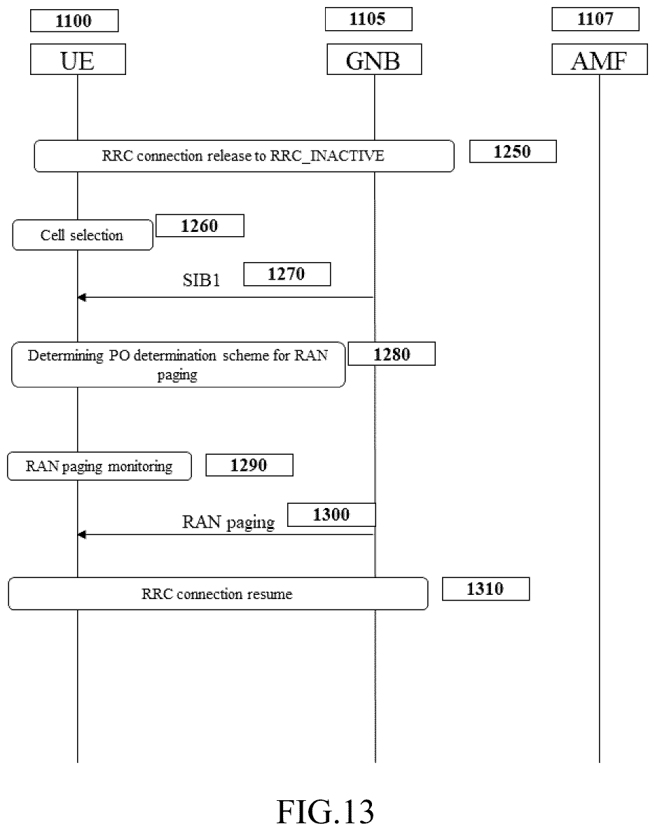

FIG. 12 and FIG. 13 illustrate operations for paging transmission and paging receptions.

UE and Network perform the following for paging transmission/reception.

At 1110, upon switching on, UE performs PLMN selection and cell selection.

At 1120, UE receives MIB and SIB1 in the selected cell. UE determines whether the cell is barred or not. If the cell is not barred, UE proceeds with the RRC connection establishment procedure. If the cell is barred, UE selects another cell.

At 1130, UE performs with GNB RRC connection establishment procedure. UE transmits a RRCSetupRequest, receives a RRCSetup and transmits a RRCSetupComplete. UE and GNB establishes SRB1.

At 1140, UE transmits to GNB ULInformationTransfer that contains REGISTRATION REQUEST message. UE includes in the message an IE that indicates UE support the enhanced paging scheme (e.g. C-POG or S-POG) for NES. REGISTRATION REQUEST message is transmitted from the GNB to AMF.

At 1150, AMF transmits REGISTRATION ACCEPT to the GNB. GNB transmits to the UE DLInformationTransfer that comprises REGISTRATION ACCEPT.

REGISTRATION ACCEPT comprises:
>: 5G-GUTI that comprises 5G-S-TMSI
>: Information that the enhanced paging scheme for NES is allowed in the Tracking Area. If allowed, UE applies the enhanced paging scheme in a cell if the cell supports/allows the enhanced paging scheme for NES.

At 1160, RRC connection release for state transition to RRC_IDLE. After completion of NAS registration procedure, GNB may release RRC connection by transmitting RRCRelease.

At 1170, UE performs cell selection to find a suitable cell to camp on.

At 1180, UE receives MIB and SIB1 in the selected cell. UE determines that the cell is suitable. UE determines whether enhanced paging scheme for NES is applied in the cell. If SIB1 comprises nesPaging-SupportedIdle field, UE consider enhanced paging scheme for CN paging is supported/allowed in the cell.

At 1190, UE determines PO determination scheme for CN paging.

UE determines to use baseline paging scheme in case that:
>: UE has not reported/indicated to AMF that UE supports enhanced paging scheme or UE has not received an indication from AMF that enhanced paging scheme is allowed/supported; or
>: UE has reported/indicated to AMF that UE supports enhanced paging scheme and UE has received an indication from AMF that enhanced paging scheme is allowed/supported and SIB1 does not comprise nesPaging-SupportedIdle field.

UE determines to use enhanced paging scheme in case that:
>: UE has reported/indicated to AMF that UE supports enhanced paging scheme and UE has received an indication from AMF that enhanced paging scheme is allowed/supported and SIB1 comprises nesPaging-SupportedIdle field.

At 1200, UE performs paging monitoring for CN paging based on the determined paging scheme.

At 1210, GNB receives a paging message for the UE from AMF. GNB determines to use NES paging in case that:
>: the paging message comprises a parameter indicating that the UE support NES paging; and
>: the cell supports NES paging for CN paging (e.g. nesPaging-SupportedIdle is present)

At 1220, UE performs with GNB RRC connection establishment procedure in response to the CN paging.

At 1230, UE receives UECapabilityEnquiry and transmits UECapabilityInformation.UE CapabilityInformation may comprise nesPagingSupportInactive field.

At 1240, UE and GNB perform RRC_CONNECTED operation.

GNB determines configurations for the UE based on reported capability and cell status. GNB transmits to UE RRCReconfiguration to deliver the determined configurations. UE and GNB perform RRC_CONNECTED operation such as data transfer and mobility.

At 1250, at some point of time GNB decides to release the RRC connection and put the UE to RRC_INACTIVE state. UE receives from GNB RRCRelease. The RRCRelease comprises information on RAN paging.

At 1260, UE performs cell selection and perform state transition to RRC_INACTIVE.

At 1270, UE receives MIB and SIB1 in the selected cell. UE determines that the cell is suitable. UE determines whether enhanced paging scheme for NES is applied in the cell. If SIB1 comprises nesPaging-SupportedInactive field, UE consider enhanced paging scheme is supported/allowed in the cell for RRC_INACTIVE.

At 1280, UE determines PO determination scheme for RAN paging.

At 1290, UE performs paging monitoring in RRC_INACTIVE.

At 1300, GNB determines to initiate RAN paging for the UE. GNB determines to use NES paging in case that:
>: the RNA of the UE supports NES paging for RAN paging (e.g. nesPaging-SupportedInactive is present in SIB1 of cells of the RNA); and
>: UE supports NES paging in RRC_INACTIVE (e.g. UECapabilityInformation comprises nesPagingSupportInactive field)

At 1310, UE and GNB perform RRC connection resume procedure in response to receiving RAN paging

If UE state mismatch occurs between UE and Network, CN paging can be transmitted to the UE. If the UE in RRC_INACTIVE receives a CN paging message, UE switches back to ‘paging monitoring by UE in RRC_IDLE’ operation.

### <Paging Monitoring>

To perform paging monitoring, UE and network use same T. There are many factors/parameters that affects T, UE and network choose T properly based on given configurations.

### CASEs to be Considered

To facilitate the discussion, following cases are defined.
>: CASE1: UE is operating in eDRX for CN paging;
>; CASE2: UE is not operating in eDRX for CN paging;
>: CASE3: UE is operating in eDRX with T_RAN_E (>1024) for RAN paging;
>: CASE4: UE is operating in eDRX with T_RAN_E (=<1024) for RAN paging;
>: CASE5: UE is not operating in eDRX for RAN paging.

For UE in RRC_IDLE, CASE 1 and CASE 2 are valid. UE determines the CASE as in table below.

TABLE 5

| UE is configured | eDRX-AllowedIdle | | |
|---|---|---|---|
| for eDRX by | is signal | | |
| upper layers | led in SIB1 | CASE | raw |
| Yes | Yes | CASE1 | 1 |
| Yes | No | CASE2 | 2 |
| No | Yes | CASE2 | 3 |
| No | No | CASE2 | 4 |

UE in RRC_INACTIVE determines the CASE as in table below.

TABLE 6

| | eDRX- | | eDRX- | | |
|---|---|---|---|---|---|
| UE is configured | AllowedInactive-r18 | UE is configured | AllowedInactive-r17 | | |
| for eDRX by ran- | is signalled | for eDRX by ran- | is signalled | | |
| ExtendedPagingCycle-r18 | in SIBI | ExtendedPagingCycle-r17 | in SIB1 | CASE | Raw |
| Y | Y | Y | Y | NA | 1 |
| Y | Y | Y | N | NA | 2 |
| Y | Y | N | Y | CASE3 | 3 |
| Y | Y | N | N | CASE3 | 4 |
| Y | N | Y | Y | NA | 5 |
| Y | N | Y | N | NA | 6 |
| Y | N | N | Y | CASE5 | 7 |
| Y | N | N | N | CASE5 | 8 |
| N | Y | Y | Y | CASE4 | 9 |
| N | Y | Y | N | CASE5 | 10 |
| N | Y | N | Y | CASE5 | 11 |
| N | Y | N | N | CASE5 | 12 |
| N | N | Y | Y | CASE4 | 13 |
| N | N | Y | N | CASE5 | 14 |
| N | N | N | Y | CASE5 | 15 |
| N | N | N | N | CASE5 | 16 |

A UL in RRC_INACTIVE can be in a combination of cases as in table below.

TABLE 7

| operating in eDRX | operating in eDRX | |
|---|---|---|
| for CN paging | for RAN paging | Description |
| Yes | Yes | CASE1 + CASE 3/4 |
| Yes | No | CASE1 + CASE5 |
| No | Yes | Not possible |
| No | No | CASE2 + CASE5 |

T is determined as in table below.

TABLE 8

| | | T | Raw |
|---|---|---|---|
| UE does not operate | CASE2 or | Shortest of | 1 |
| in eDRX | CASE2 + CASE5 | [T_RAN, T_CN, T_D] | |
| UE in RRC_IDLE | CASE1 | [T_E_CN] | 2 |
| operates in eDRX; | T_E_CN =< 1024 | | |
| | CASE1 | During CN configured PTW | 3 |
| | T_E_CN > 1024; | Shortest of | |
| | During CN_PTW | [T_CN, T_D] | |
| | | Outside the CN configured PTW, | |
| | | UE does not monitor paging and T is not | |
| | | used | |
| UE in | CASE1 + CASE3 | Shortest of | 4 |
| RRC_INACTIVE | T_E_CN =< 1024; | [T_E_RAN, T_E_CN] | |
| operates in eDRX; | T_E_RAN =< 1024 | | |
| | CASE1 + CASE3 | During CN configured PTW, | 5 |
| | T_E_CN > 1024; | Shortest of | |
| | T_E_RAN =< 1024 | [T_CN, T_E_RAN, T_D]. | |
| | | Outside the CN configured PTW, | |
| | | T_E_RAN] | |
| | CASE1 + CASE5 | Shortest of | 6 |
| | T_E_CN =< 1024; | [T_RAN, T_E_CN] | |
| | Not operating in eDRX | | |
| | for RAN paging | | |
| | CASE1 + CASE5 | During CN configured PTW, | 7 |
| | T_E_CN > 1024; | Shortest of | |
| | Not operating in eDRX | [T_RAN, T_CN, T_D]. | |
| | for RAN paging | Outside the CN configured PTW, | |
| | | [T_RAN]. | |
| | CASE1 + CASE4 | During the overlapped part of CN | 8 |
| | T_E_CN > 1024; | configured PTW and RAN configured PTW, | |
| | T_E_RAN > 1024 | Shortest of | |
| | | [T_RAN, T_CN, T_D]. | |
| | | During CN configured PTW and outside | |
| | | RAN configured PTW, | |
| | | Shortest of | |
| | | [T_CN, T_D]. | |
| | | Outside CN configured PTW and during | |
| | | RAN configured PTW | |
| | | [T_RAN] | |
| | | Outside CN configured PTW and | |
| | | outside RAN configured PTW | |
| | | UE does not monitor paging and T is not | |
| | | used | |

first_T, first_N: parameters/inputs that are used to determine the specific frame that contains the reference time point (reference PMO, first PMO).

Second_T, second_N: parameters/inputs that are used to determine PO index.

For UE in RRC_IDLE: first_T and second_T are identical/same; first_N and second_N are identical/same.

For UE in RRC_INACTIVE: first_T and second_T are different in specific cases; First_N and second_N are different in the specific cases; first_T and second_T are same in other cases. First_N and second_N are same in other cases.

### Paging Monitoring by UE in RRC IDLE

If nesPaging-SupportedIdle is not configured (not signalled in SIB1) or if nesPaging-SupportedIdle is configured and UE does not operate in NES paging:
>: UE determines a T based on:
>>: Raw1 of Table 8 in case of CASE2 (raw2, 3 or 4 of table5);
>>: Raw2 of Table 8 in case of CASE1 (raw1 of Table 5) with T_E_CN=<1024 radio frames; or
>>: Raw3 of Table 8 in case of CASE1 (raw1 of Table 5) with T_E_CN>1024 radio frames;
>: UE determines a PO index (i_s) based on following equation:

$$≫ : i\_s = ( UE\_ID div N ) mod Ns$$

>>: N is determined based on the T and nAndPagingFrameOffset
>>: (UE_ID div N) indicates an integer associated with a second set of UEs that the UE belongs to.
>: UE determines a specific frame based on the following equation:

$$≫ : ( SFN + PF\_offset ) mod T = ( T div N ) * ( UE\_ID mod first\_N$$

>>: (T div N) is a dispersing factor
>>: (UE_ID mod N) indicates an integer associated with s a first set of UEs that the UE belongs to.
>>: N is determined based on T and nAndPagingFrameOffset.
>: UE determines a first PMO of the specific frame based on pagingSearchSpace
>: UE determines one or more PMOs based on the PO index and firstPDCCH-MonitoringOccasionOfPO and the first PMO.
>: UE determines a subset of PMOs of the one or more PMOs based on RSRPs of SSBs
>: UE monitors the subset of PMOs based on P-RNTI.

If nesPaging-SupportedIdle is configured (signalled in SIB1) and C-POG parameters are signalled in SIB1 and UE operates in NES paging:
>: UE determines a T based on:
>>: Raw1 of Table 8 in case of CASE2 (raw2, 3 or 4 of Table 5);
>>: Raw2 of Table 8 in case of CASE1 (raw1 of Table 5) with T_E_CN=<1024 radio frames; or
>>: Raw3 of Table 8 in case of CASE1 (raw1 of Table 5) with T_E_CN>1024 radio frames;
>: UE determines a PO index (i_s) based on following equation:

$$≫ : i\_s = ( UE\_ID div N ) mod Ns$$

>>: N is determined based on the T and nAndPagingFrameOffset
>>: (UE_ID div N) indicates an integer associated with a second set of UEs that the UE belongs to.
>: UE determines a specific frame based on the following equation:

$$( SFN + PF\_offset ) mod T = ( UE\_ID mod N )$$

>>: dispersing factor is not applied to condense POGs
>>: (UE_ID mod N) indicates an integer associated with s a first set of UEs that the UE belongs to.
>>: N is determined based on T and nAndPagingFrameOffset.
>: UE determines a first PMO of the specific frame based on pagingSearchSpace
>: UE determines one or more PMOs based on the PO index and firstPDCCH-MonitoringOccasionOfPO and the first PMO
>: UE determines a subset of PMOs of the one or more PMOs based on RSRPs of SSBs
>: UE monitors the subset of PMOs based on P-RNTI.

If nesPaging-SupportedIdle is configured (signalled in SIB1) and S-POG parameters are signalled in SIB1 and UE operates in NES paging:
>: UE determines a T based on:
>>: Raw1 of Table 8 in case of CASE2 (raw2, 3 or 4 of Table 5);
>>: Raw2 of Table 8 in case of CASE1 (raw1 of Table 5) with T_E_CN=<1024 radio frames; or
>>: Raw3 of Table 8 in case of CASE1 (raw1 of Table 5) with T_E_CN>1024 radio frames;
>: UE determines a PO index (i_s) based on following equation:

$$i\_s = UE\_ID mod Ns$$

>>: Ns is determined based on nsExt (or other relevant parameters)
>: UE determines a specific frame based on the following equation:

$$SFN mod T = PF\_offset or ( SFN + PF\_offset ) mode T = 0$$

>>: PF_offset is determined based on frameOffset
>: UE determines a first PMO of the specific frame based on pagingSearchSpace
>: UE determines one or more PMOs based on the PO index and firstPDCCH-MonitoringOccasionOfPO and the first PMO
>: UE determines a subset of PMOs of the one or more PMOs based on RSRPs of SSBs
>: UE monitors the subset of PMOs based on P-RNTI.

### Paging Monitoring by UE in RRC INACTIVE

If nesPaging-SupportedInactive is not configured (not signalled in SIB1) or UE does not operate in NES paging:
>: UE determines a first_T based on:
>>: Raw1 of Table 8 in case of CASE2 (raw2, 3 or 4 of table5)+CASE5 (raw7, 8, 10, 11, 12, 14, 15 or 16 of table6);
>>: Raw4 of Table 8 in case of:
>>>: CASE1 (raw1 of table5)+CASE3 (raw3 or 4 of table6) with T_E_CN=<1024 radio frames;
>>: Raw5 of Table 8 in case of:
>>>: CASE1 (raw1 of table5)+CASE3 (raw3 or 4 of table6) with T_E_CN>1024 radio frames;
>>: Raw6 of Table 8 in case of
>>>: CASE1 (raw1 of table5)+CASE5 (raw7, 8, 10, 11, 12, 14, 15 or 16 of table6); with T_E_CN=<1024 radio frames
>>: Raw7 of Table 8 in case of
>>>: CASE1 (raw1 of table5)+CASE5 (raw7, 8, 10, 11, 12, 14, 15 or 16 of table6); with T_E_CN>1024 radio frames
>>: Raw8 of Table 8 in case of
>>>: CASE1 (raw1 of table5)+CASE4 (raw9 or 13 of table6);
>: UE determines a PO index (i_s) based on following equation:

$$i\_s = ( UE\_ID div second\_N ) mod Ns$$

>>: second_N is determined based on a second_T and nAndPagingFrameOffset
>>>: if network does not broadcast ranPagingInIdlePO with value “true” in SIB1;
>>: the second_T is equal to the first_T.
>>: As a consequence, i_s in RRC_IDLE and i_s for RRC_INACTIVE could be different because the first_T in RRC_IDLE and first_T in RRC_INACTIVE are determined based on different facts.
>>: When UE is in RRC_IDLE, first T is determined as indicated in raw 2 and raw3 of Table 8.
>>: When UE is in RRC_INACTIVE, first T is determined as indicated in raw4˜8.
>>>: if network broadcasts ranPagingInIdlePO with value “true” in SIB1;
>>>>: If T_E_CN=<1024 radio frames and T_E_RAN=<1024
>>: the first_T is as indicated by raw4 of Table 8.
>>: the second_T is as indicated by raw2 of Table 8.
>>: As a consequence, the same i_s as for RRC_IDLE state is used for UE in RRC_INACTIVE
>>>>: If T_E_CN=<1024 radio frames and eDRX for RAN paging is not configured
>>: the first_T is as indicated by raw6 of Table 8
>>: the second_T is as indicated by raw2 of Table 8.
>>: As a consequence, the same i_s as for RRC_IDLE state is used for UE in RRC_INACTIVE
>>>>: If T_E_CN>1024 radio frames and T_E_RAN=<1024 radio frames
>>: the first_T is as indicated raw5 of Table 8
>>: the second_T is as indicated by raw3 of Table 8.
>>: As a consequence, the same i_s as for RRC_IDLE state is used for UE in RRC_INACTIVE
>>>>: If T_E_CN>1024 radio frames and eDRX for RAN paging is not configured
>>: the first_T is as indicated raw7 of Table 8
>>: the second_T is as indicated by raw3 of Table 8.
>>: As a consequence, the same i_s as for RRC_IDLE state is used for UE in RRC_INACTIVE
>>: (UE_ID div N) indicates an integer associated with a second set of UEs that the UE belongs to.
>: UE determines a specific frame based on the following equation:

$$( SFN + PF\_offset ) mod first\_T = ( first\_T div first\_N ) ⋆ ( UE\_ID mod first\_N ) .$$

>>: (first_T div first_N) is a dispersing factor.
>>: (UE_ID mod first_N) indicates an integer associated with s a first set of UEs that the UE belongs to.
>>: first_N is determined based on first_T and nAndPagingFrameOffset.
>: UE determines a first PMO of the specific frame based on pagingSearchSpace.
>: UE determines one or more PMOs based on the PO index and firstPDCCH-MonitoringOccasionOfPO and the first PMO.
>: UE determines a subset of PMOs of the one or more PMOs based on RSRPs of SSBs.
>: UE monitors the subset of PMOs based on P-RNTI.

If nesPaging-SupportedInactive is configured (signalled in SIB1) and C-POG parameters are signalled in SIB1 and UE operates in NES paging:
>: UE determines a first_T based on:
>>: Raw1 of Table 8 in case of CASE2 (raw2, 3 or 4 of table5)+CASE5 (raw7, 8, 10, 11, 12, 14, 15 or 16 of table6);
>>: Raw4 of Table 8 in case of:
>>>: CASE1 (raw1 of table5)+CASE3 (raw3 or 4 of table6) with T_E_CN=<1024 radio frames; >>: Raw5 of Table 8 in case of:
>>>: CASE1 (raw1 of table5)+CASE3 (raw3 or 4 of table6) with T_E_CN>1024 radio frames;
>>: Raw6 of Table 8 in case of
>>>: CASE1 (raw1 of table5)+CASE5 (raw7, 8, 10, 11, 12, 14, 15 or 16 of table6); with T_E_CN=<1024 radio frames
>>: Raw7 of Table 8 in case of
>>>: CASE1 (raw1 of table5)+CASE5 (raw7, 8, 10, 11, 12, 14, 15 or 16 of table6); with T_E_CN>1024 radio frames
>>: Raw8 of Table 8 in case of
>>>: CASE1 (raw1 of table5)+CASE4 (raw9 or 13 of table6);
>: UE determines a PO index (i_s) based on following equation:

$$i\_s = ( UE\_ID div second\_N ) mod Ns$$

>>: second_N is determined based on a second_T and nAndPagingFrameOffset
>>>: if network does not broadcast ranPagingInIdlePO with value “true” in SIB1;
>>>>: the second_T is equal to the first_T.
>>>>: As a consequence, i_s in RRC_IDLE and i_s for RRC_INACTIVE could be different because the first_T in RRC_IDLE and first_T in RRC_INACTIVE are determined based on different facts.
>>: When the UE is in RRC_IDLE, first T is determined as indicated in raw 2 or raw3 of Table 8.
>>: When the UE is in RRC_INACTIVE, first T is determined as indicated in raw4 8.
>>>: if network broadcasts ranPagingInIdlePO with value “true” in SIB1;
>>>>: If T_E_CN=<1024 radio frames and T_E_RAN=<1024
>>: the first_T is as indicated by raw4 of Table 8.
>>: the second_T is as indicated by raw2 of Table 8.
>>: As a consequence, the same i_s as for RRC_IDLE state is used for UE in RRC_INACTIVE
>>>>: If T_E_CN=<1024 radio frames and eDRX for RAN paging is not configured
>>: the first_T is as indicated by raw6 of Table 8
>>: the second_T is as indicated by raw2 of Table 8.
>>: As a consequence, the same i_s as for RRC_IDLE state is used for UE in RRC_INACTIVE
>>>>: If T_E_CN>1024 radio frames and T_E_RAN=<1024 radio frames
>>: the first_T is as indicated raw5 of Table 8
>>: the second_T is as indicated by raw3 of Table 8.
>>: As a consequence, the same i_s as for RRC_IDLE state is used for UE in RRC_INACTIVE
>>>>: If T_E_CN>1024 radio frames and eDRX for RAN paging is not configured
>>: the first_T is as indicated raw7 of Table 8
>>: the second_T is as indicated by raw3 of Table 8.
>>: As a consequence, the same i_s as for RRC_IDLE state is used for UE in RRC_INACTIVE
>>: (UE_ID div N) indicates an integer associated with a second set of UEs that the UE belongs to.
>: UE determines a specific frame based on the following equation:

$$( SFN + PF\_offset ) mod first\_T = UE\_ID mod first\_N .$$

>>: (UE_ID mod first_N) indicates an integer associated with s a first set of UEs that the UE belongs to.
>>: first_N is determined based on first_T and nAndPagingFrameOffset.
>: UE determines a first PMO of the specific frame based on pagingSearchSpace.
>: UE determines one or more PMOs based on the PO index and firstPDCCH-MonitoringOccasionOfPO and the first PMO.
>: UE determines a subset of PMOs of the one or more PMOs based on RSRPs of SSBs.
>: UE monitors the subset of PMOs based on P-RNTI.

If nesPaging-SupportedInactive is configured (signalled in SIB1) and S-POG parameters are signalled in SIB1 and UE operates in NES paging:
>: UE determines a first_T based on:
>>: Raw1 of Table 8 in case of CASE2 (raw2, 3 or 4 of table5)+CASE5 (raw7, 8, 10, 11, 12, 14, 15 or 16 of table6);
>>: Raw4 of Table 8 in case of:
>>>: CASE1 (raw1 of table5)+CASE3 (raw3 or 4 of table6) with T_E_CN=<1024 radio frames;
>>: Raw5 of Table 8 in case of:
>>>: CASE1 (raw1 of table5)+CASE3 (raw3 or 4 of table6) with T_E_CN>1024 radio frames;
>>: Raw6 of Table 8 in case of
>>>: CASE1 (raw1 of table5)+CASE5 (raw7, 8, 10, 11, 12, 14, 15 or 16 of table6); with T_E_CN=<1024 radio frames
>>: Raw7 of Table 8 in case of
>>>: CASE1 (raw1 of table5)+CASE5 (raw7, 8, 10, 11, 12, 14, 15 or 16 of table6); with T_E_CN>1024 radio frames
>>: Raw8 of Table 8 in case of
>>>: CASE1 (raw1 of table5)+CASE4 (raw9 or 13 of table6);
>: UE determines a PO index (i_s) based on following equation:

$$i\_s = UE\_ID mod Ns .$$

>>: Ns is determined based on nsExt (or other relevant parameters).
>>: T is not considered in PO index determination.
>>: As a consequence, i_s for RRC_IDLE and i_s for RRC_INACTIVE are same e.g. for the following cases (and all other cases):
>>>: if network does not broadcast ranPagingInIdlePO with value “true” in SIB1;
>>>: if network broadcasts ranPagingInIdlePO with value “true” in SIB1;
>>>>: If T_E_CN=<1024 radio frames and T_E_RAN=<1024;
>>>>: If T_E_CN=<1024 radio frames and eDRX for RAN paging is not configured;
>>>>: If T_E_CN>1024 radio frames and T_E_RAN=<1024 radio frames;
>>>>: If T_E_CN>1024 radio frames and eDRX for RAN paging is not configured.
>: UE determines a specific frame based on the following equation:

$$SFN mod first \_ T = PF\_offset or ( SFN + PF\_offset ) mode first\_T = 0$$

>>: PF_offset is determined based on frameOffset
>: UE determines a first PMO of the specific frame based on pagingSearchSpace.
>: UE determines one or more PMOs based on the PO index and firstPDCCH-MonitoringOccasionOfPO and the first PMO.
>: UE determines a subset of PMOs of the one or more PMOs based on RSRPs of SSBs.
>: UE monitors the subset of PMOs based on P-RNTI.

Paging scheme is determination based on NES paging indication in NAS message and NES paging indication in system information

Terminal may perform followings:
>: transmitting by the terminal to AMF a message of a first protocol layer [NAS]
>>: the message comprises an IE indicating that the terminal supports NES paging (enhanced paging, enhanced paging scheme . . . )
>: receiving by the terminal from the AMF a message of the first protocol layer
>>: the message comprises an IE indicating that NES paging is allowed to the terminal in a one or more TAs (indicated by TAI list in the message)
>: receiving by the terminal from a base station a system information
>: determining by the terminal one or more PMOs
>: performing PDCCH monitoring for paging in the one or more PMOs
>: wherein:
>: the one or more PMOs are determined based on a first method in case that:
>>: NES paging is allowed by upper layers (e.g. NAS message comprising a first NES paging information has been received);
>>: NES paging is allowed by the base station in the cell (e.g. system information comprising a second NES paging information has been received);
>: the one or more PMOs are determined based on a second method in case that:
>>: NES paging is not allowed by upper layer (e.g. NAS message comprising the first NES paging indication has not been received); or
>>: NES paging is allowed by upper layer but NES paging is not allowed by the base station (or NES paging is not allowed in the cell).
>: In the first method:
>>: A specific frame is determined based on a first equation:
>>>: Right side of the first equation:
>>>>: comprise ‘DRX cycle’ and ‘an integer derived from UE ID [UE_ID]’ and ‘an integer derived from the DRX cycle (indicating the number of RPs during a DRX cycle)’ or ‘an integer which is same for a first specific group of UE IDs [UE_ID mod N]’
>>>>: does not comprise a dispersion factor.
>>: A group of PMOs [PO; PMOG] are determined based on an index of the group of PMOs and first PMO in the specific frame.
>>: The index of the group of PMOs is determined based on a second equation:
>>>: Right side of the second equation:
>>>>: comprises ‘an integer which is same for a second specific group of UE IDs [UE_ID div N]’ and ‘an integer indicating number of PMO groups associated with a RP’;
>>: the one or more PMOs are selected from the group of PMOs based on RSRP of SSB,
>: In the second method:
>>: A specific frame is determined based on a third equation:
>>>: Right side of the third equation:
>>>>: comprise ‘DRX cycle’ and ‘an integer derived from UE ID [UE_ID]’ and ‘an integer derived from the DRX cycle (indicating the number of RPs during a DRX cycle)’ or ‘an integer which is same for a first specific group of UE IDs [UE_ID mod N]’
>>: The integer is a remainder of UE_ID divide N
>>>>: comprise a dispersion factor [T div N].
>>: The dispersion factor is a quotient of T divide N
>>: A group of PMOs [PO; PMOG] are determined based on an index of the group of PMOs and first PMO in the specific frame.
>>: The index of the group of PMOs is determined based on a second equation:
>>>: Right side of the second equation:
>>: comprises an integer which is same for a second specific group of UE IDs [UE_ID div N] and an integer indicating number of PMO groups associated with a RP,
>>: the one or more PMOs are selected from the group of PMOs based on RSRP of SSB.

Terminal may perform followings:
>: transmitting by the terminal to a AMF a first message of a first protocol layer [NAS].
>>: the message comprises an IE/parameter indicating that the terminal supports NES paging (enhanced paging, enhanced paging scheme . . . ) for CN paging (or in RRC_IDLE state).
>: receiving by the terminal from the AMF a second message of the first protocol layer.
>>: the message comprises an IE/parameter indicating that NES paging is allowed in RRC_IDLE (or for CN paging).
>: transmitting by the terminal to a base station a third message [UECapabilitylnformation] of a second protocol layer.
>>: The third message comprises a field/parameter indicating that the terminal supports NES paging for RAN paging (or in RRC_INACTIVE state).
>: receiving by the terminal from the base station a fourth message [RRCRelease] of the second protocol layer.
>>: The fourth message comprises:
>>>: a field/parameter indicating that NES paging is allowed in RRC_INACTIVE (or for RAN paging) in the RNA;
>>>: a set of parameters related to RRC_INACTIVE state (e.g. SuspendConfig).
>: receiving by the terminal a system information.
>>: The system information comprises:
>>>: An indication that NES paging is allowed in the cell for the UE in RRC_INACTIVE state
>>>: a set of parameters related to NES paging;
>: determining by the terminal one or more PMOs; and
>: performing PDCCH monitoring for paging in the one or more PMOs.
>: To determine the one or more PMOs:
>>: A specific frame is determined based on a first equation:
>>>: Right side of the first equation comprises:
>>>>: A first integer derived from UE_ID and N
>>: The first integer which is same/common for/to a first set of UE IDs [UE_ID mod N]
>>: A group of PMOs are determined based on:
>>>: an index of the group of PMOs; and
>>>: first PMO in the specific frame
>>: The index of the group of PMOs is determined based on a second equation:
>>>: Right side of the second equation comprises:
>>>>: A second integer derived from UE_ID and N
>>: The Second integer is same/common for/to a second set of UE_IDs [UE_ID div N]
>>: the one or more PMOs are selected from the group of PMOs based on RSRP of SSB The specific frame is determined based on an integer relating to the first set of UE_IDs and the index of the PO is determined based on an integer relating to the second set of UE_IDs.

Terminal may perform followings:
>: transmitting by the terminal to a AMF a first message of a first protocol layer [NAS].
>>: the message comprises an IE/parameter indicating that the terminal supports NES paging (enhanced paging, enhanced paging scheme . . . ) for CN paging (or in RRC_IDLE state).
>: receiving by the terminal from the AMF a second message of the first protocol layer.
>>: the message comprises:
>>>: an IE/parameter indicating that NES paging is allowed in RRC_IDLE (or for CN paging)
>>>: a parameter for T_CN;
>>>: a parameter for T_E_CN;
>: receiving by the terminal a system information.
>>: The system information comprises:
>>>: An indication that NES paging is allowed in the cell for the UE in RRC_IDLE state for CN paging
>>>: a set of parameters related to NES paging;
>: determining by the terminal one or more PMOs; and
>: performing PDCCH monitoring for paging in the one or more PMOs.
>: To determine the one or more PMOs:
>>: A specific frame is determined based on a first equation:
>>>: Right side of the first equation comprises:
>>>>: an integer which is same for a first set of UE_IDs [UE_ID mod N]
>>>: Left side of the first equation comprises:
>>>>: T_E_CN in case that T_E_CN is equal to or smaller than 1024 radio frames
>>>>: The shortest of T_CN and T_D in case that T_E_CN is larger than 1024 radio frames
>>: A group of PMOs are determined based on:
>>>: an index of the group of PMOs; and
>>>: first PMO in the specific frame
>>: The index of the group of PMOs is determined based on a second equation:
>>>: Right side of the second equation comprises:
>>>>: an integer derived from UE_ID and N
>>>>: The integer is same for a second set of UE_IDs the one or more PMOs are selected from the group of PMOs based on RSRP of SSB

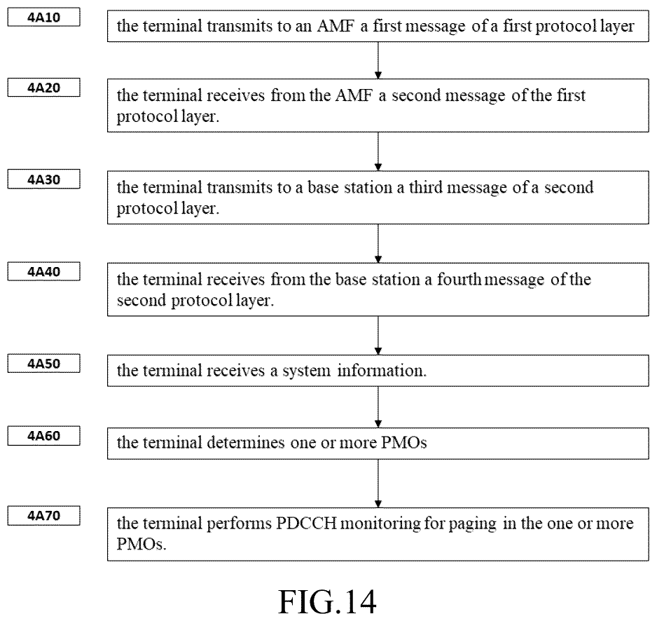

FIG. 14 illustrates UE operation for enhanced paging.
>: At 4A10, the terminal transmits to an AMF a first message of a first protocol layer [NAS].
>>: the message comprises an IE/parameter indicating that the terminal supports NES paging (enhanced paging, enhanced paging scheme . . . ) for CN paging (or in RRC_IDLE state).
>: At 4A20, the terminal receives from the AMF a second message of the first protocol layer.
>>: the message comprises:
>>>: an IE/parameter indicating that NES paging is allowed in RRC_IDLE (or for CN paging)
>>>: a parameter for T_CN;
>>>: a set of parameters for T_E_CN;
>: At 4A30, the terminal transmits to a base station a third message [UECapabilitylnformation] of a second protocol layer.
>>: The third message comprises a field/parameter indicating that the terminal supports NES paging for RAN paging (or in RRC_INACTIVE state).
>: At 4A40, the terminal receives from the base station a fourth message [RRCRelease] of the second protocol layer.
>>: The fourth message comprises:
>>>: a field/parameter indicating that NES paging is allowed in RRC_INACTIVE (or for RAN paging);
>>>: a parameter for T_RAN;
>>>: a set of parameters for T_E_RAN
>: a set of parameters related to RRC_INACTIVE state
>: At 4A50, the terminal receives a system information.
>>: The system information comprises:
>>>: An indication that NES paging is allowed in the cell for the UE in RRC_IDLE state (for CN paging);
>>>: An indication that NES paging is allowed in the cell for the UE in RRC_INACTIVE (both for CN paging and RAN paging);
>>>: a set of parameters related to NES paging;
>: At 4A60, the terminal determines one or more PMOs; and
>: At 4A70, the terminal performs PDCCH monitoring for paging in the one or more PMOs.
>: To determine the one or more PMOs:
>>: A specific frame is determined based on a first equation:
>>>: Right side of the first equation comprises:
>>>>: A first_N and UE_ID
>>>: Left side of the first equation comprises:
>>>>: A first_T and PF_offset
>>: A group of PMOs are determined based on:
>>>: an index of the group of PMOs; and
>>>: first PMO in the specific frame
>>: The index of the group of PMOs is determined based on a second equation:
>>>: Right side of the second equation comprises:
>>>>: A second_N
>>: the one or more PMOs are selected from the group of PMOs based on RSRP of SSB.
>: The first_T and the first_N are same as the second_T and second_N in case that ranPagingInIdlePO is not comprised in SIB1.
>: In case that ranPagingInIdlePO is comprised in SIB1 and both T_E_CN and T_E_RAN are smaller than 1024 radio frames and the terminal operates in eDRX:
>>: The first_T is Shortest of [T_E_RAN, T_E_CN]; and
>>: The second_T is T_E_CN.
>: In case that ranPagingInIdlePO is comprised in SIB1 and T_E_CN is larger than 1024 radio frames and T_E_RAN is smaller than 1024 radio frames and the terminal operates in eDRX:
>>: The first_T is Shortest of [T_CN, T_E_RAN, T_D] during CN configured PTW and is T_E_RAN outside the CN configured PTW; and
>>: The second_T is shortest of [T_CN, T_D] during CN configured PTW and is T_E_RAN outside the CN configured PTW.

```
  -- ASN1START
  -- TAG-SIB1-START
```

| | |
|---|---|
| SIB1 ::= | SEQUENCE { |

...

| | |
|---|---|
| nesPaging-SupportedIdle | UMERATED {true} |

OPTIONAL, -- Need R
/// indicates whether NES paging scheme is supported for IDLE mode UE (for CN
paging)in the cell. If present, it is supported. If absent, not supported///

| | |
|---|---|
| nesPaging-SupportedInactive | UMERATED {true} |

OPTIONAL, -- Need R
/// indicates whether NES paging scheme is supported for INACTIVE mode UE (for
RAN paging)in the cell. If present, it is supported. If absent, not supported///

nesPagingSupport: This field indicates whether the cell supports enhanced paging scheme. If absent, enhanced paging scheme is not supported by the network in the cell. This field indicates whether enhanced paging scheme is allowed in the cell. If absent, enhanced paging scheme is not allowed in the cell.

PCCH-Config ::= SEQUENCE {

| | |
|---|---|
| defaultPagingCycle | PagingCycle, /// this field indicates |

T_D///

| | |
|---|---|
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| frameOffset | INTEGER (0..32) |

OPTIONAL

| | |
|---|---|
| ns | ENUMERATED {four, two, one}, |
| nsExt | ENUMERATED |

{thirteen-two, sixteen, eight} OPTIONAL

| | |
|---|---|
| nsScaleFactor | ENUMERATED |

```
{eight, four, two, one}, OPTIONAL
    firstPDCCH-MonitoringOccasionOfPO CHOICE {
      sCS15KHZoneT
SEQUENCE (SIZE (1..maxPO-perPF)) OF INTEGER (0..139),
      sCS30KHZoneT-SCS15KHZhalfT
SEQUENCE (SIZE (1..maxPO-perPF)) OF INTEGER (0..279),
      sCS60KHZoneT-SCS30KHZhalfT-SCS15KHZquarterT
SEQUENCE (SIZE (1..maxPO-perPF)) OF INTEGER (0..559),
      sCS120KHZoneT-SCS60KHZhalfT-SCS30KHZquarterT-
```

| | |
|---|---|
| SCS15KHZoneEigthT | SEQUENCE (SIZE (1..maxPO-perPF)) OF |

INTEGER (0..1119),
sCS120KHZhalfT-SCS60KHZquarterT-SCS30KHZoneEighthT-

| | |
|---|---|
| SCS15KHZoneSixteenthT | SEQUENCE (SIZE (1..maxPO-perPF)) OF INTEGER |

(0..2239),
sCS480KHZoneT-SCS120KHZquarterT-SCS60KHZoneEighthT-

| | |
|---|---|
| SCS30KHZoneSixteenthT | SEQUENCE (SIZE (1..maxPO-perPF)) OF INTEGER |

```
(0..4479),
      sCS480KHZhalfT-SCS120KHZoneEighthT-SCS60KHZoneSixteenthT
SEQUENCE (SIZE (1..maxPO-perPF)) OF INTEGER (0..8959),
      sCS480KHZquarterT-SCS120KHZoneSixteenthT
SEQUENCE (SIZE (1..maxPO-perPF)) OF INTEGER (0..17919)
```

| | | |
|---|---|---|
| } | OPTIONAL, | -- Need R |

```
    ...,
    [[
```

| | |
|---|---|
| nrofPDCCH-MonitoringOccasionPerSSB-InPO-r16 | INTEGER (2..4) |

```
OPTIONAL -- Cond SharedSpectrum2
    ]],
    [[
```

| | |
|---|---|
| ranPagingInIdlePO-r17 | ENUMERATED |

| | |
|---|---|
| {true} | OPTIONAL, -- Need R |

firstPDCCH-MonitoringOccasionOfPO-v1710 CHOICE {

| | |
|---|---|
| sCS480KHZoneEighthT | SEQUENCE (SIZE (1..maxPO-perPF)) |

OF INTEGER (0..35839),

| | |
|---|---|
| sCS480KHZoneSixteenthT | SEQUENCE (SIZE (1..maxPO-perPF)) OF |

```
INTEGER (0..71679)
  }
OPTIONAL -- Need R
    ]]
  }
```

nAndPagingFrameOffset

In case that:
>: frameOffset is absent; or
>: frameOffset is present and the UE does not support S-POG (enhanced scheme),
value in this field is used to derive the number of total paging frames in first_T (corresponding to parameter N in TS 38.304 [20]) and paging frame offset (corresponding to parameter PF_offset in TS 38.304 [20]). A value of oneSixteenthT corresponds to first_T/16, a value of oneEighthT corresponds to first_T/8, and so on.
   frameOffset

In case frameOffset is present and UE supports S-POG (enhanced scheme):
>: nAndPagingFrameOffset is ignored; and
>: value in this field is used to derive the paging frame offset (corresponding to parameter PF_offset in TS 38.304 [20]);
>: this field present only if S-POG is used/applied. Otherwise, absent.
   ns

In case that:
>: nsExt/nsScaleFactor is absent; or
>: nsExt/nsScaleFactor is present and the UE does not support S-POG (enhanced scheme),
value in this field indicates number of paging occasions per paging frame (reference point).
   nsExt

In case that nsExt is present and UE supports S-POG (enhanced scheme):
>: ns is ignored;
>: value in this field indicates number of paging occasions in a first_T (DRX cycle) or number of paging occasions in a default DRX cycle; and
>: this field present only if S-POG is used/applied. Otherwise, absent.
   nsScaleFactor

In case that nsScaleFactor is present and UE supports S-POG (enhanced scheme):
>: value in this field together with the value in ns field are used to derive number of paging occasions in a first_T (DRX cycle) or number of paging occasions in a default DRX cycle.
>>: Number of paging occasions=nsScaleFactor*ns
>: this field present only if S-POG is used/applied. Otherwise, absent.

The RRCRelease message is used to command the release of an RRC connection or the suspension of the RRC connection.

```
  -- ASN1START
  -- TAG-RRCRELEASE-START
```

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

```
    }
  }
```

| | |
|---|---|
| RRCRelease-IEs ::= | SEQUENCE { |
| redirectedCarrierInfo | RedirectedCarrierInfo |

OPTIONAL, -- Need N

| | |
|---|---|
| cellReselectionPriorities | CellReselectionPriorities |

OPTIONAL, -- Need R

| | |
|---|---|
| suspendConfig | SuspendConfig |

OPTIONAL, -- Need R

| | |
|---|---|
| deprioritisationReq | SEQUENCE { |
| deprioritisationType | ENUMERATED {frequency, nr}, |
| deprioritisationTimer | ENUMERATED {min5, min10, |

min15, min30}
}
OPTIONAL, -- Need N

| | |
|---|---|
| lateNonCriticalExtension | OCTET STRING |

OPTIONAL,

| | |
|---|---|
| nonCriticalExtension | RRCRelease-v1540-IEs |

```
OPTIONAL
  }
  ...
```

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, ///This field indicates |

T_RAN///

| | |
|---|---|
| ran-NotificationAreaInfo | RAN-NotificationAreaInfo |

OPTIONAL, -- Need M

| | |
|---|---|
| t380 | PeriodicRNAU-TimerValue |

OPTIONAL, -- Need R

| | |
|---|---|
| nextHopChainingCount | NextHopChainingCount, |

```
    ...,
    [[
```

| | |
|---|---|
| sl-UEIdentityRemote-r17 | RNTI-Value |

OPTIONAL, -- Cond L2RemoteUE

| | |
|---|---|
| sdt-Config-r17 | SetupRelease { SDT-Config-r17 } |

OPTIONAL, -- Need M

| | |
|---|---|
| srs-PosRRC-Inactiver-r17 | SetupRelease { SRS-PosRRC-Inactive- |
| r17 } | OPTIONAL, -- Need M |
| ran-ExtendedPagingCycle-r17 | ExtendedPagingCycle-r17 |

```
OPTIONAL -- Cond RANPaging ///This field indicates T_E_RAN///
    ]],
    [[
```

| | |
|---|---|
| ncd-SSB-RedCapInitialBWP-SDT-r17 | SetupRelease |
| {NonCellDefiningSSB-r17} | OPTIONAL -- Need |

```
M
    ]],
    [[
```

| | |
|---|---|
| resumeIndication-r18 | ENUMERATED {true} |

OPTIONAL, -- Need N

| | |
|---|---|
| srs-PosRRC-Inactive-v1800 | SetupRelease { SRS-PosRRC- |
| Inactive-v1800 } | OPTIONAL, -- Need M |
| srs-PosRRC-InactiveValidityAreaPreConfigList-r18 | SetupRelease { SRS- |

PosRRC-InactiveValidityAreaPreConfigList-r18 } OPTIONAL, -- Need M

| | |
|---|---|
| srs-PosRRC-InactiveValidityAreNonPreConfig-r18 | SetupRelease { SRS- |

PosRRC-InactiveValidityAreaConfig-r18 } OPTIONAL, -- Need M

| | |
|---|---|
| ran-ExtendedPagingCycleConfig-r18 | ExtendedPagingCycleConfig-r18 |
| OPTIONAL, -- Cond RANPaging | ///This field indicates T_E_RAN/// |
| multicastConfigInactive-r18 | SetupRelease { MulticastConfigInactive- |
| r18 } | OPTIONAL -- Need M |

]]

| | |
|---|---|
| nesPaging-AllowedInactiveRNA | ENUMERATED {true} |

```
  /// if this field present, US consider NES paging is supported/allowed in the RNA
indicated by RNA-AreaConfig///
  /// if this field is abset, UE determines NES paging is supported/allowed based on
SIB1///
  }
```

| | |
|---|---|
| PagingCycle ::= | ENUMERATED {rf32, rf64, rf128, rf256} |
| RAN-NotificationAreaInfo ::= | CHOICE { |
| cellList | PLMN-RAN-AreaCellList, |
| ran-AreaConfigList | PLMN-RAN-AreaConfigList, |

```
    ...
  }
```

| | |
|---|---|
| RAN-AreaConfig ::= | SEQUENCE { |
| trackingAreaCode | TrackingAreaCode, |
| ran-AreaCodeList | SEQUENCE (SIZE (1..32)) OF |
| RAN-AreaCode | OPTIONAL -- Need R |

}

| | |
|---|---|
| ExtendedPagingCycle-r17 ::= | ENUMERATED {rf256, rf512, rf1024, |

spare1}

| | |
|---|---|
| ExtendedPagingCycleConfig-r18 ::= | SEQUENCE { |
| extendedPagingCycle-r18 | ENUMERATED {hf2, hf4, hf8, hf16, |

hf32, hf64, hf128,hf256, hf512, hf1024,

spare6, spare5,

spare4, spare3, spare2, spare1},

| | |
|---|---|
| pagingPTWLength-r18 | ENUMERATED {ms1280, ms2560, |

ms3840, ms5120, ms6400, ms7680, ms8960, ms10240, ms11520,

ms12800, ms14080,

ms15360, ms16640, ms17920, ms19200, ms20480, ms21760,

ms23040, ms24320,

ms25600, ms26880, ms28160, ms29440, ms30720, ms32000,

ms33280, ms34560,

```
ms35840, ms37120, ms38400, ms39680, ms40960}
  }
  }
  -- TAG-RRCRELEASE-STOP
  -- ASN1STOP
```

CellReselectionPriorities: Dedicated priorities to be used for cell reselection as specified in TS 38.304. The maximum number of NR carrier frequencies that the network can configure through FreqPriorityListNR and FreqPriorityListDedicatedSlicing together is eight. If the same frequency is configured in both FreqPriorityListNR and FreqPriorityListDedicatedSlicing, the frequency is only counted once.

CnType: Indicate that the UE is redirected to EPC or 5GC.

DeprioritisationReq: Indicates whether the current frequency or RAT is to be deprioritised.

DeprioritisationTimer: Indicates the period for which either the current carrier frequency or NR is deprioritised. Value minN corresponds to N minutes.

MeasIdleConfig: Indicates measurement configuration to be stored and used by the UE while in RRC_IDLE or RRC_INACTIVE.

NoLastCellUpdate: Presence of the field indicates that the last used cell for PEI shall not be updated. When the field is absent, the PEI-capable UE shall update its last used cell with the current cell. The UE shall not update its last used cell with the current cell if the AS security is not activated.

srs-PosRRC-Inactive: SRS for positioning configuration during RRC_INACTIVE state. The configuration also includes bandwidth aggregation and frequency hopping.

srs-PosRRC-InactiveValidityAreaNonPreConfig: Contains the SRS for positioning configuration to be applied immediately and which is valid across a number of cells comprising a validity area during RRC_INACTIVE state.

srs-PosRRC-InactiveValidityAreaPreConfigList: Contains the SRS for positioning configurations to be applied when a trigger for an event is met and which is valid across a number of cells comprising a validity area during RRC_INACTIVE state. For each validity area, the UE is preconfigured with only one SRS for positioning configuration.

SuspendConfig: Indicates configuration for the RRC_INACTIVE state. The network does not configure suspendConfig when the network redirect the UE to an inter-RAT carrier frequency or if the UE is configured with a DAPS bearer.

The REGISTRATION REQUEST message is sent by the UE to the AMF. The message comprises:
>: Requested DRX parameters that contains 5GS DRX parameters
>: Requested extended DRX parameters contains Extended DRX parameters
>: NES paging support. If this IE is included, UE supports enhanced scheme for paging (e.g. NES paging)

The REGISTRATION ACCEPT message is sent by the AMF to the UE. The message comprises:
>: Negotiated DRX parameters that contains 5GS DRX parameters;
>: Negotiated extended DRX parameters that contains Extended DRX parameters;
>: NES-paging-allowed. If included, UE consider enhanced scheme for paging (e.g. NES paging) is used in a cell that supports the enhanced scheme.
   5GS DRX parameters IE

5GS DRX parameters information element indicates that the UE wants to use DRX and for the network to indicate the DRX cycle value to be used at paging. The IE comprises DRX value field. This field represents the DRX cycle parameter ‘T’. This value is denoted T_CN.

### Extended DRX Parameters IE

Extended DRX parameters information element indicate that the UE wants to use eDRX and for the network to indicate the Paging Time Window length value and the extended DRX cycle value to be used for eDRX. eDRX value field indicates T_E_CN. Paging Time Window field indicates PTW

When extended DRX (eDRX) is used, the following applies:
>: For RRC_INACTIVE, eDRX configuration for RAN paging is decided and configured by NG-RAN. In RRC_INACTIVE the UE monitors both RAN and CN paging;
>: For RRC_IDLE, eDRX for CN paging is configured by upper layers. In RRC_IDLE the UE monitors only CN paging;
>: Information on whether eDRX for CN paging and RAN paging is allowed on the cell is provided separately in system information;
>: The maximum value of the eDRX cycle is 10485.76 seconds (2.91 hours) while the minimum value of the eDRX cycle is 2.56 seconds;
>: The hyper SFN (H-SFN) is broadcast by the cell and increments by one when the SFN wraps around;
>: Paging Hyperframe (PH) refers to the H-SFN in which the UE starts monitoring paging according to DRX during a Paging Time Window (PTW). The PH and PTW are determined based on a formula (see TS 38.304 [10]) that is known by the AMF, UE and NG-RAN;
>: H-SFN, PH and PTW are used if the eDRX cycle is greater than 10.24 seconds;
>: When the RRC_IDLE eDRX cycle is longer than the system information modification period, the UE verifies that stored system information remains valid before resuming/establishing an RRC connection.

If the UE does not operate in eDRX:
>: T is determined by the shortest of the UE specific DRX value configured by RRC (if any), the UE specific DRX value configured by upper layers (if any), and a default DRX value broadcast in system information. For L2 U2N Relay UE, T for a L2 U2N Remote UE is determined by the shortest of the UE specific DRX value provided in PC5-RRC signalling and a default DRX value broadcast in system information.

In RRC_IDLE state, if the UE operates in eDRX and eDRX is configured by upper layers, i.e., T_E_CN, according to clause 7.4:
>: If T_E_CN is no longer than 1024 radio frames:
>>: T=T_E_CN;
>: else:
>>: During CN configured PTW, T is determined by the shortest of UE specific DRX value, if configured by upper layers, and the default DRX value broadcast in system information.

In RRC_INACTIVE state, if the UE operates in eDRX and eDRX is configured by RRC, i.e., T_eDRX_RAN (if any), and upper layers, i.e., T_E_CN:
>: If both T_E_CN and used T_eDRX_RAN are no longer than 1024 radio frames, T=min{T_eDRX_RAN, T_E_CN}.
>: If T_E_CN is no longer than 1024 radio frames and no T_eDRX_RAN is configured or used, T is determined by the shortest of UE specific DRX value configured by RRC and T_E_CN.
>: If T_E_CN is longer than 1024 radio frames:
>>: If T_eDRX_RAN is not configured or used:
>>>: During CN configured PTW, T is determined by the shortest of the UE specific DRX value configured by RRC, the UE specific DRX value configured by upper layers (if any), and a default DRX value broadcast in system information. Outside the CN configured PTW, T is determined by the UE specific DRX value configured by RRC;
>>: else if used T_eDRX_RAN is no longer than 1024 radio frames:
>>>: During CN configured PTW, T is determined by the shortest of the UE specific DRX value, if configured by upper layers and T_eDRX_RAN, and a default DRX value broadcast in system information. Outside the CN configured PTW, T is determined by T_eDRX_RAN;
>>>>: else if used T_eDRX_RAN is longer than 1024 radio frames:
>>>: During the overlapped part of CN configured PTW and RAN configured PTW, T is determined by the shortest of the UE specific DRX value configured by RRC, the UE specific DRX value configured by upper layers (if any), and a default DRX value broadcast in system information;
>>>: During CN configured PTW and outside RAN configured PTW, T is determined by the shortest of the UE specific DRX value configured by upper layers (if any), and a default DRX value broadcast in system information;
>>>: Outside CN configured PTW and during RAN configured PTW, T is determined by the UE specific DRX value configured by RRC.
N: number of total paging frames in T
Ns: number of paging occasions for a PF
PF_offset: offset used for PF determination
UE_ID:
If the UE operates in eDRX as specified in clause 7.4:
>: 5G-S-TMSI mod 4096
else:
>: 5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signalled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration.

If the UE has no 5G-S-TMSI, for instance when the UE has not yet registered onto the network, the UE shall use as default identity UE_ID=0 in the PF and i_s formulas above. 5G-S-TMSI is a 48 bit long bit string as defined in TS 23.501 [10]. 5G-S-TMSI shall in the formulae above be interpreted as a binary number where the left most bit represents the most significant bit.

In RRC_INACTIVE state, if the UE supports inactiveStatePO-Determination and the network broadcasts ranPaginglnldlePO with value “true”, the UE shall use the same i_s as for RRC_IDLE state. Otherwise, the UE determines the i_s based on the parameters and formula above.

In RRC_INACTIVE state, if used eDRX value configured by upper layers is no longer than 1024 radio frames, the UE shall use the same i_s as for RRC_IDLE state.

In RRC_INACTIVE state, if used eDRX value configured by upper layers is longer than 1024 radio frames, during CN PTW, the UE shall use the same i_s as for RRC_IDLE state. Outside CN PTW, the UE shall use the i_s for RRC_INACTIVE state.

The UE may be configured by upper layers and/or RRC with an extended DRX (eDRX) cycle T_E_CN and/or T_eDRX_RAN.

For CN paging, the UE operates in eDRX in RRC_IDLE or RRC_INACTIVE states if the UE is configured for eDRX by upper layers and eDRX-Allowedldle is signalled in SIB1; otherwise, the UE does not operate in eDRX.

For RAN paging, the UE in RRC_INACTIVE state:
>: if the UE is configured for eDRX by ran-ExtendedPagingCycle-r18 and eDRX-AllowedInactive-ri8 is signalled in SIB1:
>: operates in eDRX with an eDRX cycle T_eDRX_RAN configured by extendedPagingCycle-r18;
>: else if the UE is configured for eDRX by ran-ExtendedPagingCycle-r] and eDRX-AllowedInactive-r17 is signalled in SIB1:
>: operates in eDRX with an eDRX cycle T_eDRX_RAN configured by ran-ExtendedPagingCycle-r17;
>: else:
>: does not operate in eDRX.

If the UE operates in eDRX with an eDRX cycle no longer than 1024 radio frames, it monitors POs as defined in 7.1 with configured eDRX cycle. Otherwise, a UE operating in eDRX monitors POs as defined in 7.1 during a periodic Paging Time Window (PTW) configured for the UE. The PTW is UE-specific and is determined by a Paging Hyperframe (PH), a starting position within the PH (PTW_start) and an ending position (PTW_end). PH, PTW_start and PTW_end are given by the following formula:

The PH for CN is the H-SFN satisfying the following equations:

$$H - SFN mod T\_E \_CN = ( UE\_ID \_H mod T\_E \_CN ) ,$$

where
>: T_E_CN: UE-specific eDRX cycle in Hyper-frames, (T_E_CN=2, . . . , 1024 Hyper-frames) configured by upper layers.

The PH for RAN is the H-SFN satisfying the following equations:

$$H - SFN mod T\_E \_RAN = ( UE\_ID \_H mod T\_E \_RAN ) ,$$

>: T_E_RAN: UE-specific eDRX cycle in Hyper-frames, (T_E_RAN=2, . . . , 1024 Hyper-frames) configured by RRC.

For CN configured PTW:

PTW_start denotes the first radio frame of the PH for CN that is part of the PTW and has SFN satisfying the following equation:

$$SFN = 128 ⋆ i\_eDRX \_CN ,$$

>: i_eDRX_CN=floor(UE_ID_H/T_E_CN) mod 8

PTW_end is the last radio frame of the PTW and has SFN satisfying the following equation:

$$SFN = ( PTW\_start + L ⋆ 100 - 1 ) mod 1024 ,$$

>: L=Paging Time Window (PTW) length (in seconds) configured by upper layers For RAN configured PTW:

PTW_start denotes the first radio frame of the PH for RAN that is part of the PTW and has SFN satisfying the following equation:

$$SFN = 128 ⋆ {i}_{eDRX \_ CN} ,$$

>: i_{eDRX_CN}=floor(UE_ID_H/T_{eDRX_CN}) mod 8

PTW_end is the last radio frame of the PTW and has SFN satisfying the following equation:

$$SFN = ( PTW\_start + L ⋆ 100 - 1 ) mod 1024 ,$$

>: L=Paging Time Window (PTW) length (in seconds) configured by RRC
UE ID_H is defined as follows:
UE_ID_H: 13 most significant bits of the Hashed ID.
Hashed ID is defined as follows:

Hashed_ID is Frame Check Sequence (FCS) for the bits b31, b30 . . . , b0 of 5G-S-TMSI. 5G-S-TMSI=<b47, b46, . . . , b0> as defined in TS 23.003 [23].

The 32-bit FCS shall be the ones complement of the sum (modulo 2) of Y1 and Y2, where Y1 and Y2 are defined in TS 38.304.

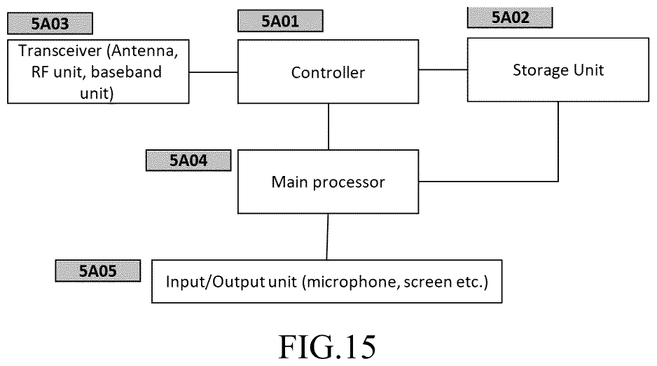

FIG. 15 is a block diagram illustrating the internal structure of a Terminal to which the disclosure is applied.

Referring to the diagram, the terminal includes a controller (5A01), a storage unit (5A02), a transceiver (5A03), a main processor (5A04) and I/O unit (5A05).

The controller (5A01) controls the overall operations of the terminal in terms of mobile communication. For example, the controller (5A01) receives/transmits signals through the transceiver (5A03). In addition, the controller (5A01) records and reads data in the storage unit (5A02). To this end, the controller (5A01) includes at least one processor. For example, the controller (5A01) may include a communication processor (CP) that performs control for communication and an application processor (AP) that controls the upper layer, such as an application program. The controller controls storage unit and transceiver such that UE operations illustrated in this disclosure are performed.

The storage unit (5A02) stores data for operation of the terminal, such as a basic program, an application program, and configuration information. The storage unit (5A02) provides stored data at a request of the controller (5A01).

The transceiver (5A03) consists of a RF processor, a baseband processor and plurality of antennas. The RF processor performs functions for transmitting/receiving signals through a wireless channel, such as signal band conversion, amplification, and the like. Specifically, the RF processor up—converts a baseband signal provided from the baseband processor into an RF band signal, transmits the same through an antenna, and down—converts an RF band signal received through the antenna into a baseband signal. The RF processor may include a transmission filter, a reception filter, an amplifier, a mil0r, an oscillator, a digital—to—analog converter (DAC), an analog—to—digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (5A04) controls the overall operations other than mobile operation. The main processor (5A04) process user input received from I/O unit (5A05), stores data in the storage unit (5A02), controls the controller (5A01) for required mobile communication operations and forward user data to I/O unit (5A05).

I/O unit (5A05) consists of equipment for inputting user data and for outputting user data such as a microphone and a screen. I/O unit (5A05) performs inputting and outputting user data based on the main processor's instruction.

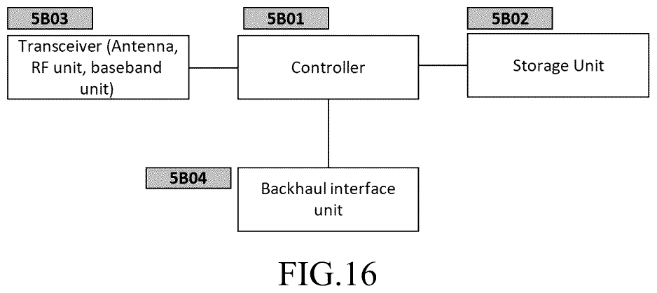

FIG. 16 is a block diagram illustrating the configuration of a base station according to the disclosure.

As illustrated in the diagram, the base station includes a controller (5B01), a storage unit (5B02), a transceiver (5B03) and a backhaul interface unit (5B04).

The controller (5B01) controls the overall operations of the main base station. For example, the controller (5B01) receives/transmits signals through the transceiver (5B03), or through the backhaul interface unit (5B04). In addition, the controller (5B01) records and reads data in the storage unit (5B02). To this end, the controller (5B01) may include at least one processor. The controller controls transceiver, storage unit and backhaul interface such that base station operation illustrated in FIG. 3 are performed.

The storage unit (5B02) stores data for operation of the main base station, such as a basic program, an application program, and configuration information. Particularly, the storage unit (5B02) may store information regarding a bearer allocated to an accessed UE, a measurement result reported from the accessed UE, and the like. In addition, the storage unit (5B02) may store information serving as a criterion to deter mine whether to provide the terminal with multi—connection or to discontinue the same. In addition, the storage unit (5B02) provides stored data at a request of the controller (5B01).

The transceiver (5B03) consists of an RF processor, a baseband processor and plurality of antennas. The RF processor performs functions for transmitting/receiving signals through a wireless channel, such as signal band conversion, amplification, and the like. Specifically, the RF processor up—converts a baseband signal provided from the baseband processor into an RF band signal, transmits the same through an antenna, and down—converts an RF band signal received through the antenna into a baseband signal. The RF processor may include a transmission filter, a reception filter, an amplifier, a mil0r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (5B04) provides an interface for communicating with other nodes inside the network. The backhaul interface unit (5B04) converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | RA-RNTI | Random Access RNTI |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | SDAP | Service Data Adaptation Protocol |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | SSS | Secondary Synchronisation Signal |
| PDCP | Packet Data Convergence Protocol | SUL | Supplementary Uplink |
| PDSCH | Physical Downlink Shared Channel | TM | Transparent Mode |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | CRP | Cell Reselection Priority |
| PRB | Physical Resource Block | PSS | Primary Synchronisation Signal |
| PUCCH | Physical Uplink Control Channel | PUSCH | Physical Uplink Shared Channel |

What is claimed is:

1. A method performed by a terminal, the method comprising:
receiving a system information, wherein the system information comprises:
a parameter related to radio frame; and
a parameter related to index;
determining a specific radio frame based on:
the parameter related to radio frame in case that a second parameter related to radio frame is not present in the system information; and
the second parameter related to radio frame in case that the second parameter related to radio frame is present in the system information;
determining a specific index;
determining a specific set of monitoring occasions based on the specific index and the specific radio frame; and
monitoring at least one monitoring occasion of the specific set of monitoring occasions.

2. The method of claim 1,
wherein the specific index is determined based on:
the parameter related to index in case that a second parameter related to index is not present in the system information; and
the second parameter related to index in case that the second parameter related to index is present in the system information.

3. The method of claim 2,
wherein the specific set of monitoring occasions consists of a specific number of monitoring occasions.

4. The method of claim 3,
wherein the specific number is determined based on a number of synchronization signal blocks.

5. The method of claim 4,
wherein first monitoring occasion of the specific set of monitoring occasions is determined based on the specific index and the specific number.

6. The method of claim 5,
wherein the first monitoring occasion of the specific set of monitoring occasions is determined further based on:
a parameter related to the first monitoring occasion in case that the parameter related to the first monitoring occasion is present in the system information and a second parameter related to the first monitoring occasion is not present in the system information; and
the second parameter related to the first monitoring occasion in case that the second parameter related to the first monitoring occasion is present in the system information.

7. The method of claim 6, wherein:
the second parameter related to the first monitoring occasion comprises one or more values;
a specific value of the one or more values indicates the first monitoring occasion of the specific set of monitoring occasions; and
the specific value is determined based on the specific index.

8. The method of claim 1,
wherein the specific set of monitoring occasions occurs every Discontinuous Reception (DRX) cycle.

9. The method of claim 1,
wherein the specific radio frame is determined further based on a Discontinuous Reception (DRX) cycle.

10. The method of claim 2, wherein:
in case that the system information comprises a parameter related to radio access network (RAN) paging:
the specific radio frame is determined further based on a value derived from a second Discontinuous Reception (DRX) cycle and a fourth DRX cycle; and
the specific index is determined further based on a value derived from the second DRX cycle, and
in case that the system information does not comprise the parameter related to RAN paging:
the specific radio frame is determined further based on the value derived from the second DRX cycle and the fourth DRX cycle; and
the specific index is determined further based on the value derived from the second DRX cycle and the fourth DRX cycle.

11. The method of claim 10, in case that the system information comprises a parameter related to idle mode paging, wherein:
the specific radio frame is determined further based on a value derived from a first DRX cycle and a third DRX cycle; and
the specific index is determined further based on the value derived from the first DRX cycle and the third DRX cycle.

12. The method of claim 11, wherein:
the first DRX cycle and the second DRX cycle are configured based on a first downlink message, wherein the first downlink message is generated by an AMF; and
the third DRX cycle and the fourth DRX cycle are configured based on a second downlink message, wherein the second downlink message is generated by a base station.

13. A terminal in a wireless communication system, the terminal comprising:
a transceiver configured to transmit and receive a signal; and
a controller configured to control the transceiver to:
receive a system information, wherein the system information comprises:
a parameter related to radio frame; and
a parameter related to index;
determine a specific radio frame based on:
the parameter related to radio frame in case that a second parameter related to radio frame is not present in the system information; and
the second parameter related to radio frame in case that the second parameter related to radio frame is present in the system information;
determine a specific index;
determine a specific set of monitoring occasions based on the specific index and the specific radio frame; and
monitor at least one monitoring occasion of the specific set of monitoring occasions.
